(19) United States
(12) Patent Application Publication
(10) Pub. No.: US 2004/0117290 A1
(43) Pub. Date: Jun. 17, 2004

(54) Automated method and system to perform a supply-side evaluation of a transaction request

(76) Inventor: Nachum Shacham, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/318,428

(22) Filed: Dec. 13, 2002

(51) Int. Cl. G06F 17/60

(52) U.S. Cl. 705/37; 705/10

(57) ABSTRACT

A system and automated method operate to evaluate a transaction request. A plurality of objects associated with the transaction request are identified, each of the plurality of objects including a set of the object attributes, each object attribute representing a respective attribute of the transaction request. A set of metric functions, each associated with a respective metric of a plurality of metrics, is applied against the sets of the object attributes to generate an object score for each object. The object scores for each of the plurality of objects are irrigated to generate a request score indicative of an overall evaluation of the transaction request relative to an expectation for the transaction request.

### FIELD OF THE INVENTION

The present invention relates generally to the field of commerce and, more specifically, to systems and methods for creating transaction quotes and/or evaluating and/or responding to transaction requests.

### BACKGROUND OF THE INVENTION

Suppliers of assets and services are continually faced with the task of deciding whether to accept, reject or counter-offer requests, reflecting interest from potential buyers to purchase or gain the right to purchase a product or service at specific terms. In retail, where products are sold by pre-established list prices, the decision is simply to accept the items in the request offered at list price, and to reject the other offers. In other markets, supplies are required to make more sophisticated acceptance and rejection decisions. For example, a specific request for products may involve evaluating the business value of the request utilizing multiple prior-defined criteria. Requests that do not meet the supplier-defined criteria may be rejected out of hand or, alternatively, the supplier may send back to the buyer a response in the form of a counter proposal (or counter offer). The counter proposal typically specifies alternate terms under which purchase would be acceptable to the supplier.

The evaluation of the business value of a request based on seller-defined criteria becomes challenging when the complexity and number of supplier-defined criteria increase, the number of products or services referenced by a request increases, and a large number of requests are received within a short time frame. For example, when participating within an electronic commerce facility (e.g., a business-to-business exchange), a supplier may receive a large number of requests in a short time frame. Further, participants within such electronic commerce facilities often expect a short turnaround for responses. Indeed, where a particular supplier is competing against a large number of other suppliers to fulfill a request, even a short delay in providing a response may result in that response not being considered by the buyer.

It is currently common practice for suppliers to evaluate requests and respond to requests through a manual process, which is slow and error prone. Further, when an evaluation finds that a request falls short of a supplier's expectation for business value (e.g., profit margin requirements), the supplier is often challenged to identify changes or modifications to the original request that can be included within a counter-proposal to the buyer, and still provide acceptable business value to the supplier. A manual process may lead to large expenses, long delays in responding to requests, and ultimately a loss of profits for the supplier.

Further, in order to provide a timely response, a supplier may choose to forego a quantitative analysis and respond with a less than optimal counter offer, or of response. This may in turn lead to lost sales, or sales that do not provide sufficient business value to the supplier.

### SUMMARY OF THE INVENTION

According to one aspect of the present invention, there is provided computer-implemented method to evaluate a transaction request. A plurality of objects associated with the transaction request are identified, each of the plurality of objects including a set of the object attributes, each object attribute representing a respective attribute of the transaction request. A set of metric functions, each associated with a respective metric of a plurality of metrics, is applied against the sets of the object attributes to generate an object score for each object. The object scores for each of the plurality of objects are aggregated to generate a request score indicative of an overall evaluation of the-transaction request relative to an expectation for the transaction request.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram providing an architectural description of an evaluation and response system, according to an exemplary embodiment of the present invention.

FIG. 2 is a block diagram illustrating the structure of an exemplary transaction request, and also illustrates examples of enterprise data that may comprise input to the evaluation and response system.

FIG. 3 is a process diagram illustrating a scoring process, according to an exemplary embodiment of the present invention, to evaluate a transaction request by generating a request score 13.

FIGS. 4A-4E show tables including exemplary values for line item object attributes, enterprise data, metrics, normalized metrics and object scores.

FIGS. 5A-C shows graphs plotting normalizing functions, according to respective exemplary embodiments of the present invention.

FIG. 6 is a diagrammatic representation of a transaction request evaluation, according to one embodiment of the present invention, to illustrate the utilization of different attribute values from different line item objects, by a collection of metrics and normalizing functions that each implement a normalized scoring process.

FIG. 7 is a flow chart illustrating a method, according to an exemplary embodiment of the present invention, of evaluating a transaction request.

FIG. 8 is a diagrammatic representation of an exemplary evaluation of dependent metric values in order to achieve equilibrium.

FIG. 9 is a diagram illustrating how the teachings of the present invention may be utilized to generate a request score for a multi-product transaction request, in one exemplary embodiment of the present invention.

FIG. 10 is a diagram illustrating conceptually how a request score may be adjusted by the recommendation engine to correspond more closely with a target score, according to one exemplary embodiment of the invention.

FIG. 11 is a diagrammatic representation of the modification, according to one embodiment of the present invention, by the recommendation engine of an original transaction request to generate a number of modified transaction requests.

FIG. 12 is a diagrammatic representation illustrating at a high level the processes that are performed within the recommendation engine, in one example of the present invention.

FIG. 13 illustrates a conceptual view of the exemplary recommendation engine as comprising a rules engine and recommendation generation algorithms, which interact to generate a one or more modified transaction requests as output.

FIG. 14 is a flowchart illustrating an automated method, according to an exemplary embodiment of the present invention, of generating a response to a transaction request (e.g., a request for quote).

FIG. 15 is a flowchart providing further details regarding a method, according to one embodiment of the present invention, of generating one or more modified transaction requests based on an original transaction request.

FIG. 16 is a flowchart illustrating a method, according to an exemplary embodiment of the present invention, of performing a line item substitution operation.

FIG. 17 is a flowchart illustrating a method, according to an exemplary embodiment of the present invention, of performing a line item attribute modification operation.

FIG. 18 is a graph providing a graphic depiction of an example in which the invention operates to incrementally increase a line item score for a line item object from an original line item score to a modified line item score that corresponds to a goal score.

FIG. 19 is a flowchart illustrating a method, according to an exemplary embodiment of the present invention, via which a goal score for a line item object of a transaction request may be computed.

FIGS. 20-33 illustrates a number of exemplary user interfaces, generated by browser utilizing HTML generated by the Web server, that facilitate user interaction with the evaluation and response system.

FIG. 34 is a diagrammatic representation of a machine in the exemplary form of computer system within which software, in the form of a series of machine-readable instructions, for performing any one of the methods discussed above may be executed.

### DETAILED DESCRIPTION

An automated method and system to perform a supply-side evaluation of a transaction request are described. In the following description, for purposes of explanation, numerous specific details are set forth in order to provide a thorough understanding of the present invention. It will be evident, however, to one skilled in the art that the present invention may be practiced without these specific details.

According to a first aspect of the present invention, there is provided an automated method and system to evaluate requests according to supplier-defined criteria that are, in one embodiment, expressed as metrics and targets, where targets may be specific reference values for metrics. While the evaluation of requests is described as being performed by a supplier of assets (e.g., products and services), the automated method and system may also be used by a buyer to evaluate a request utilizing metrics and targets before communicating the request to a supplier. According to a second aspect of the present invention there is provided an automated method and system to generate responses to requests, the responses meeting (or approaching) supply-defined targets. The systems and methods described herein are based on computation in a generic problem space applicable to multiple industries. The automated system and methods for evaluation are, for example, applicable both in markets in which terms are flexible (e.g., discrete component, telecommunication capacity, and shipment services markets) and inflexible (e.g., retail markets). The automated systems and methods to recommend responses may find broadest application in the markets in which terms (e.g., price) are flexible.

In one embodiment of the present invention, the automated methods and systems operate to (a) evaluate and utilize (1) data embodied in a request, (2) enterprise data and/or (3) target data to evaluate a request, and to provide an indication as to whether a request, under the terms received, provides a predetermined business value and/or to (b) provide recommendations for alternative terms that provide better business value for the supplier.

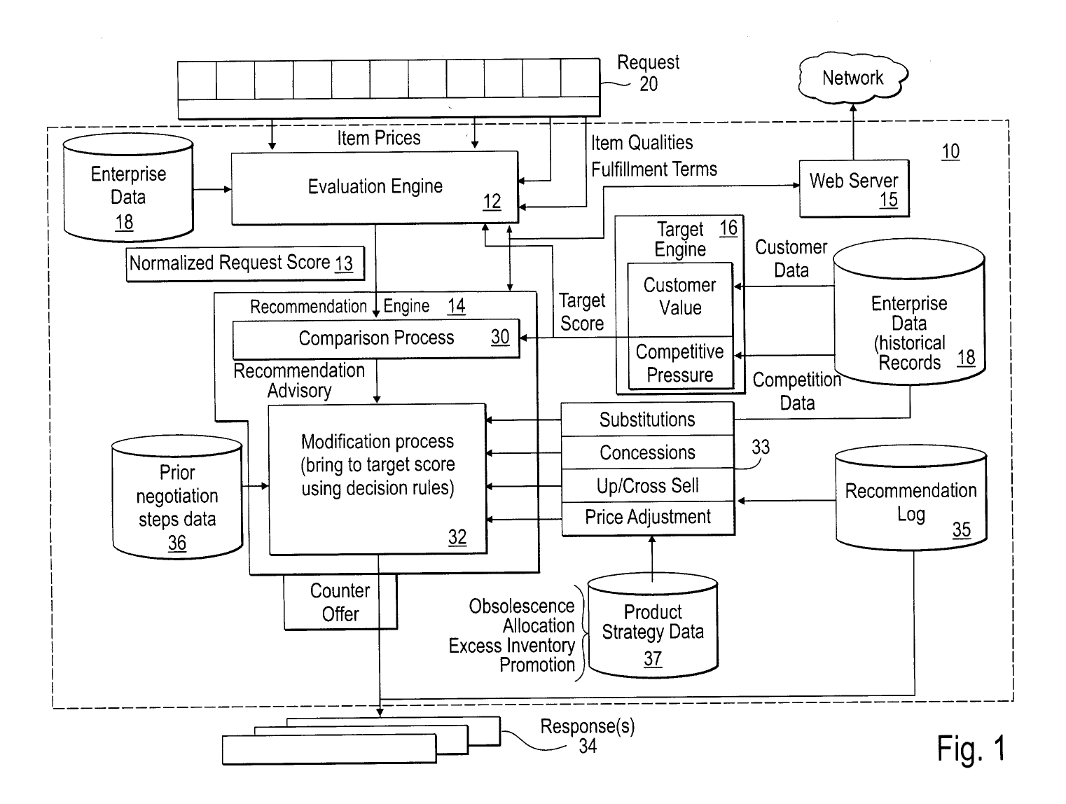

FIG. 1 is a block diagram providing an architectural description of an evaluation and response system 10, according to an exemplary embodiment of the present invention. The evaluation and response system 10 may be utilized as a component within a larger system (e.g., an order management system (not shown)). The evaluation and response system 10 includes an evaluation engine 12, a recommendation engine 14 and a target engine 16. Each of the engines 12, 14 and 16 is shown to receive as input in the form of enterprise data 18 to assist the respective engines 12, 14 and 16 to perform specific tasks.

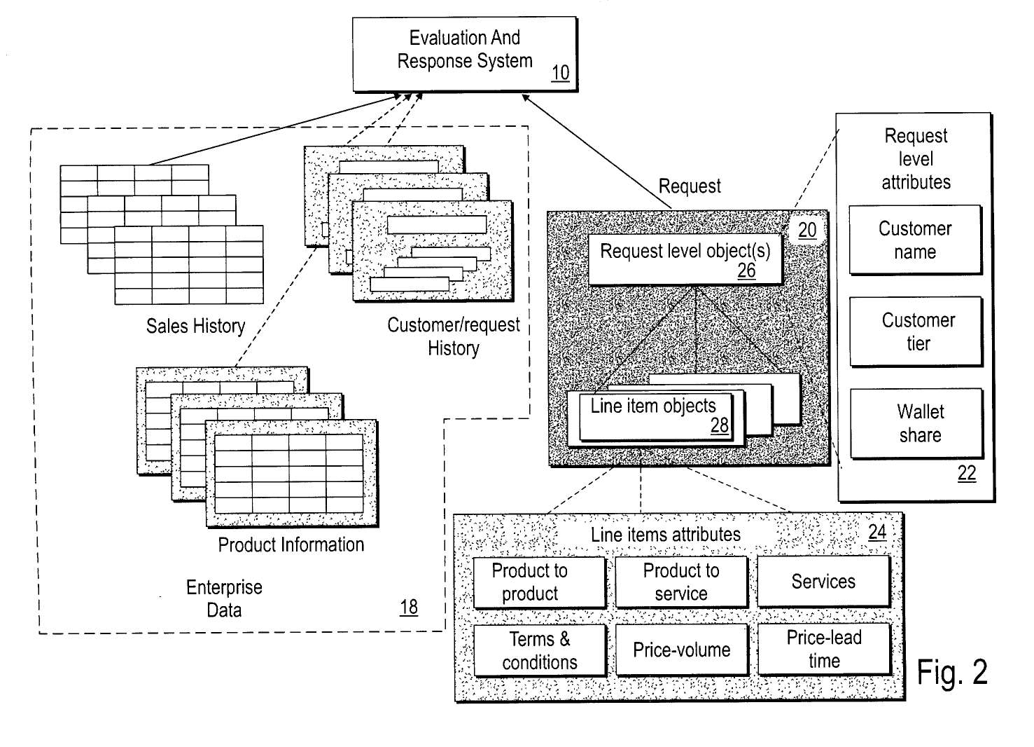

Turning firstly to the evaluation engine 12, the evaluation engine 12 is shown to receive two inputs, namely one or more requests 20 and enterprise data 18. FIG. 2 is a block diagram illustrating the structure of an exemplary transaction request 20, and also illustrates examples of enterprise data 18 that may comprise input to the evaluation and response system 10. The request 20 may represent different sales opportunities such as, for example, a request for quote (RFQ), a request for a price agreement with non-binding purchase commitments, or an order for line items specified within the transaction request 20. A transaction request 20 may be defined in terms of attributes, an attribute being a variable that can take attribute values (e.g., in a range of real values or from a set of ordered or unordered components). Attributes may furthermore be viewed as comprising request-level attributes 22 that are applicable to a transaction request 20 as a whole, and line item attributes 24 that are applicable to line items within a request. A line item may comprise an asset (e.g., a product or a service) to which the request pertains. Illustrated examples of request-level attributes include, for example, a customer name, payment terms, total dollar amount of the purchase, and a customer tier. The customer tier attribute refers to an importance attributed to the relevant customer by the evaluation and response system 10. The payment terms incorporate such factors as the timing and currency of payment.

Examples of line item attributes 24 pertaining to a particular line item may include, for example, price, lead time cost, quantity, etc. It will accordingly be appreciated that both request-level and line item attributes 22 and 24 may be included within the transaction request 20 as received at the evaluation and response system 10, or may be incorporated into the transaction request 20 by the system 10 once received. For example, a price attribute for a particular line item would typically be specified within the raw request as received at the evaluation and response system 10, whereas a cost attribute may be included in the request 20 subsequent to receipt by the system 10.

In one embodiment, the various attributes of a request 20 are embodied in objects that constitute the request 20. For the purposes of the present specification, the term objects shall be taken to include a set of attributes. In one embodiment, a request includes both request-level objects 26, each including a set of request-level attributes 22, and line item objects 28, each including a set of line item attributes 24. A particular line item object 28 relates to a particular line item (e.g., a component) that is supplied by an operator of the evaluation and response system 10. Objects 26 and 28 within a request 20 may furthermore constitute a collection of objects known as an object set. Objects 26 and/or 28 within a set may be a linear list of objects, or may have a hierarchical relationship with each other. For example, where a line item object 28 includes attributes describing a line item that constitutes an assembly, the various components that make up the assembly may each in turn be described by a respective line item object 28 that has a hierarchical relationship with respect to the line item objects 28 describing the assembly. A set of objects comprising a linear list would typically be included within a request 20 for Built to Stock (BTS) products, whereas a set of objects having a hierarchical relationship would typically be included within a request 20 for Built to Order (BTO) products.

FIG. 2 also shows enterprise data 18 as constituting an input to the evaluation and response system 10, the enterprise data 18 being utilized, as will be described below, to evaluate values for metrics according to which objects 26 and 28 in requests 20. Ultimately the request 20 itself may be evaluated. The enterprise data 18 is shown to include, for example, sales history information, customer/request history information, and product information.

Referring to FIG. 1, a request 20 received by the evaluation and response system 10 is stored locally, and enterprise data 18 describing the assets specified by the request 20 is loaded into the evaluation and response system 10 and linked to corresponding objects 26 and 28 specified in the request 20.

Thereafter, the evaluation engine 12, as will be described in further detail below, calculates a normalized request score 13 that is indicative of an overall evaluation of the transaction request 20, relative to an expectation. In one embodiment this expectation is expressed in terms of one or more targets for metrics against which the transaction request 20 is evaluated.

The normalized request score 13 is then communicated from the evaluation engine 12 to a recommendation engine 14. The recommendation engine 14 implements a comparison process 30 whereby the request score 13 is compared to a target score, representing an expectation with respect to the request 20 based on a set of metrics. The target score, in one embodiment, is generated based on a number of criteria, including a customer value of a customer from which the request 20 originates, and competitive pressures pertaining to assets to which the request 20 relates.

The comparison process 30 outputs a recommendation advisory to a modification process 32 that generates a modified transaction request, in an exemplary form of a counter offer, based on the transaction request 20. The modified transaction request has a modified request score that corresponds more closely to the target score than the original request score 13 of the original transaction request 20. Preferably, the modified request score of the modified transaction request embodied in the counter offer equals the target score. The modification process 32 may also generate multiple modified transaction requests, each based on the original transaction request 20. Each of these modified transaction requests may then be outputted from the evaluation and response system 10 as responses 34 to the original transaction request 20, and communicated to the originator of the transaction request 20.

The modification process 32 utilizes decision rules to bring a modified request score into correspondence with the target request score. Specifically, the decision rules make automated decisions as to whether to accept the terms and conditions embodied in the original transaction request 20 and to communicate such an acceptance as a response 34, or whether to generate a plurality of modified transaction requests be communicated as responses 34. For example, a decision rule may compare the normalized request score 13 to a predetermined threshold within a range, and decide to accept the terms and conditions of the original transaction request 20 if the normalized request score is within a particular range. Ultimately, if the normalized request score 13 is outside the particular range, a plurality of modified transaction requests may be communicated as responses 34.

In one embodiment, the decision rules include a continuous and combinatorial optimization algorithm to create a number of modified transaction requests by automatically setting modified values to request 20 attributes. Each of the modified transaction requests has a score that is equal to or above the target score and that is therefore acceptable to the supplier. The modified transaction requests may differ from each other in attributes and attribute values, thereby each representing unique modified transaction requests that are presented as responses 34 for possible selection to a buyer.

The modification process 32 is shown in FIG. 1 to receive a number of inputs that specify the parameters within which the modified transaction requests may be generated. For example, information regarding asset substitutions, concessions, up and cross selling opportunities, and price adjustments are inputted to the modification process 32. This information may be dynamically derived from product strategy data 37 (e.g., data regarding product obsolescence, product allocation, excess product inventory or product promotion). A recommendation log 35 created by the system 10 may also contribute towards the parameter information 33. The recommendation log 35 contains information about past modification decisions and their outcomes. In one embodiment the modification process 32 uses such data to improve the selection of substitute products for line items and to identify concessions that the customer is likely to accept.

Finally, the modification process 32 also receives negotiation data 36, concerning prior negotiation steps, as an input to enable the modification process 32 to take cognizance of terms and conditions with respect to the transaction request 20 that have already been negotiated, and threshold positions that have already been expressed.

Having above given a high level overview of the architecture of the evaluation and response system 10, a more detailed discussion is provided below regarding evaluation and recommendation algorithms that may be implemented within the evaluation engine 12 and the recommendation engine 14.

At a high level, evaluation algorithms implemented by the evaluation engine 12 evaluate object sets (e.g., including both request-level objects 26 and line item objects 28) based upon multiple metric functions that deliver respective metric values. Each metric value in turn expresses an evaluation of an object (or set of objects) relative to a target value for each of the metric functions. In one embodiment, the metric values are further subject to normalizing functions, weighing functions and aggregating functions to deliver a normalized request score 13 that represents an evaluation of a transaction request 20 as a whole. In one embodiment of the present invention, a metric function is a function of one or more attributes of a transaction request 20 (e.g., attributes of both request-level and line item objects 26 and 28). Examples of metric functions include a discount function, a standard margin percentage function, a present value of money function and a customer ranking (or tier) function.

The algorithms within the recommendation engine 14 operate to generate one or more modified transaction requests, based on an original transaction request 20. The modified transaction requests may serve as recommendations to be communicated as a response 34 from the evaluation and response system 10. In one embodiment, a modified transaction request constitutes an object set, corresponding to an object set of an original transaction request 20, that has attribute values modified (or objects substituted) such that the respective score for the modified request equal to, or approach, the target score for the original transaction request 20.

Evaluation Algorithms

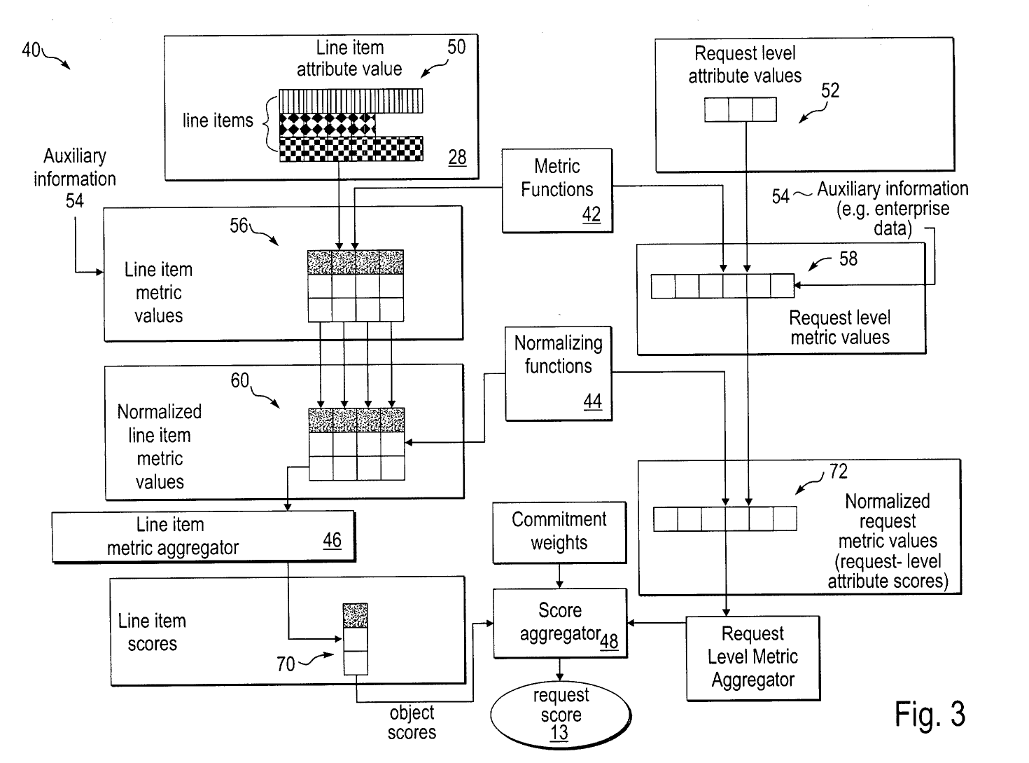

FIG. 3 is a process diagram illustrating a scoring process 40, according to an exemplary embodiment of the present invention. The scoring process 40 evaluates a transaction request 20 by generating a request score 13 indicative of an overall evaluation of the transaction request 20 relative to expectations expressed in terms of metrics and targets.

The scoring process 40, at a high level, deploys four function types, namely metric functions 42, normalizing functions 44, weighted line item metric aggregators 46 and line item score aggregators 48. FIG. 3 illustrates the data structures that provide input to, and are generated by, the various functions 42-48.

The metric functions 42 operate on line item attribute values 50 (as embodied within line item objects 28) and request-level attribute values 52 (as embodied within request-level objects 26), in conjunction with auxiliary information 54, to generate line item metric values 56 and request-level metric values 58.

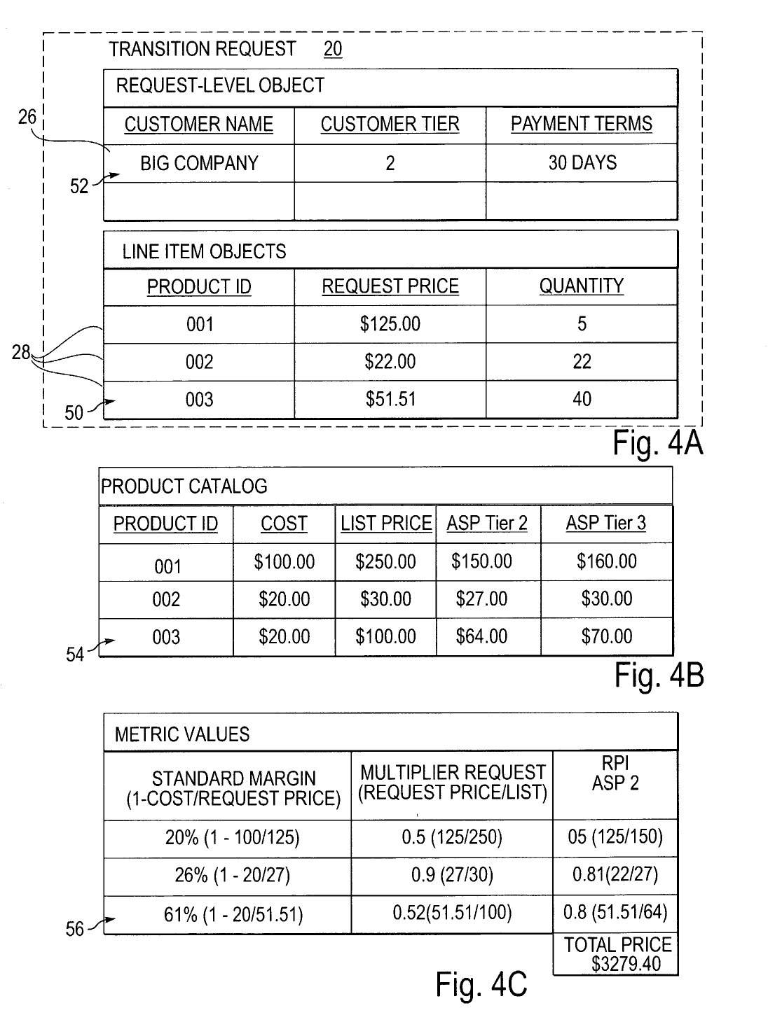

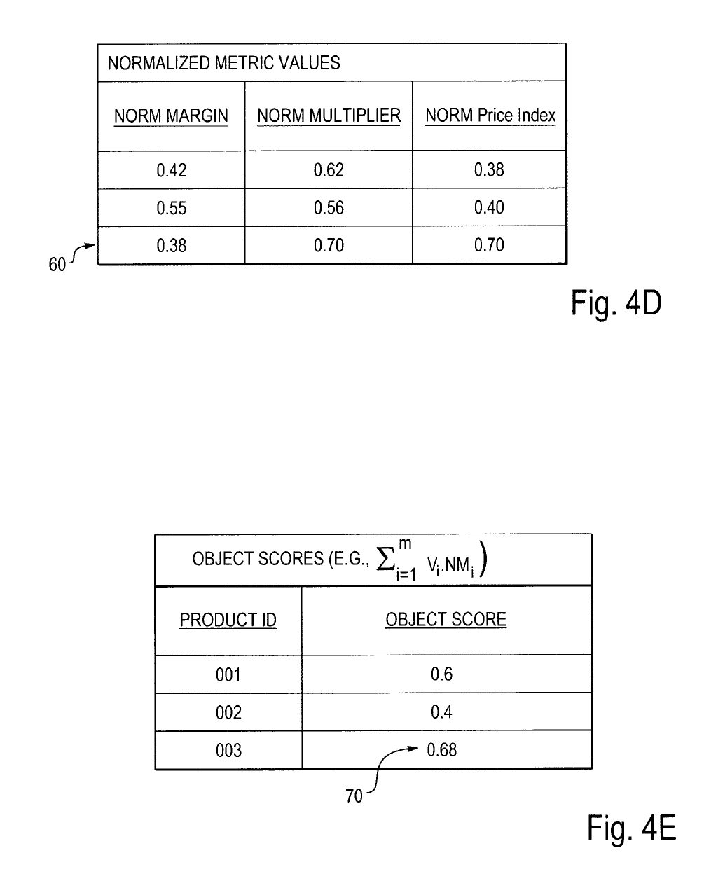

FIGS. 4A-4E provide numeric examples of the data structures discussed with reference to FIG. 3. To this end, FIG. 4A illustrates an exemplary transaction request 20 that includes a request-level object 26, and three line item objects 28. The request-level object 26 is shown to include request-level attribute values 52, and the line item objects 28 are each shown to include line item attribute values 50. For example, a line item object for a line item having a product identifier of “001” is shown to include the request price of $125.00, and a quantity request of 5.

FIG. 4B provides an example of auxiliary information 54 in the form of a product catalog, included within enterprise data 18. The product catalog includes information regarding each line item object that exists within the transaction request 20. For example, the auxiliary information 54 indicates that the line item product having a product identifier of “001” has a cost to the supplier of $100, a list price of $250.00, an Average Sale Price (ASP) of $150, for a customer tier of 2, and an ASP of $160.00 for a customer tier of 3 (ASP 2).

FIG. 4C illustrates exemplary line item metric values 56 that may be generated by a set of metric functions 42, based on the attribute values 50 and 52, and the auxiliary information 54. Specifically, the metric values 56 illustrated in FIG. 4C are generated by a standard margin metric function, a multiplier metric function, a Price Index metric function and a total price metric function. For each line item object 28 that exists within the transaction request 20, a set of line item metric values 56 are calculated by the metric functions 42. For example, the standard margin metric function calculates, for each line item object, a standard margin metric value as “1-cost/request price”; a multiplier function calculates a multiplier metric value for each line item object as “request price/list price”; a Price Index metric function (PI 1) calculates a Price Index metric value for each line item object 28 as “request price/ASP_{—}1”; and a total price metric function calculates a total price for metric value for the transaction request—the total price metric value being associated with each of the line item objects and calculated as “sum of (request price * quantity)”.

It will be appreciated that an arbitrary, finite number of metric functions 42 may be applied to the object attributes (e.g., the line item attributes and the request level attributes).

Each metric function also has multiple reference points associated therewith, for example (1) a maximum reference value (e.g., when a request price equals a list price, and a multiplier accordingly has a value of 1), (2) an expected reference value (e.g., when a metric value achieves an expected value), and (3) a minimum reference value (e.g., a multiplier reaches a predetermined acceptable minimum value. A different set of reference values for a common metric (e.g., standard margin) may exist for different objects (e.g., line objects or request-level objects), and may depend upon object attributes from one or more objects. For example, referring to FIG. 4B, a line item having a product identifier “001” may have a different set of reference values than the line item having a product identifier “002”, and a line item having a product identifier “001” may have a different set of reference points for customer tier 2 and customer tier 3. In one embodiment request level object attributes include markers for market segments, such that the metric depend on the market segment of the request.

Returning to FIG. 3, normalizing functions 44 operate to convert metric values 56 to normalized metric values 60. From the above, it will be appreciated that the line item metric values 56 and request-level metric values 58 each fall within an arbitrary range of values. Nonetheless, as described above, the range of each metric value includes multiple (e.g., three or four) reference values. The normalizing functions 44 operate with respect to each of the metric values generated by the metric functions 42 to normalize these metric values so that the set of reference values for each normalized metric value have the same value. For example, the normalizing functions 44 may operate so that a normalized maximum reference value for each normalized metric value is 1, the normalized expected reference value for each normalized metric value (ERNV) is denoted r, (0<r<1) (e.g., r=0.5), and the normalized minimum reference value for each normalized metric value is 0. Where the actual metric value falls between any of the above reference value, the normalized metric value may be computed by interpolation. Accordingly, in one embodiment, a normalizing function 44 may be regarded as being defined in terms of a number of reference points.

In one embodiment, an additional reference value may be associated with each metric value, namely a zero reference value, at which the metric value operated by the relevant metric function 42 is 0. This value is typically between the expected (or target) reference value and the minimum reference value, and may be equal to the minimum reference value. It is noted that the reference value can take values from an arbitrary set of real numbers and in particular can be negative or greater than 1.

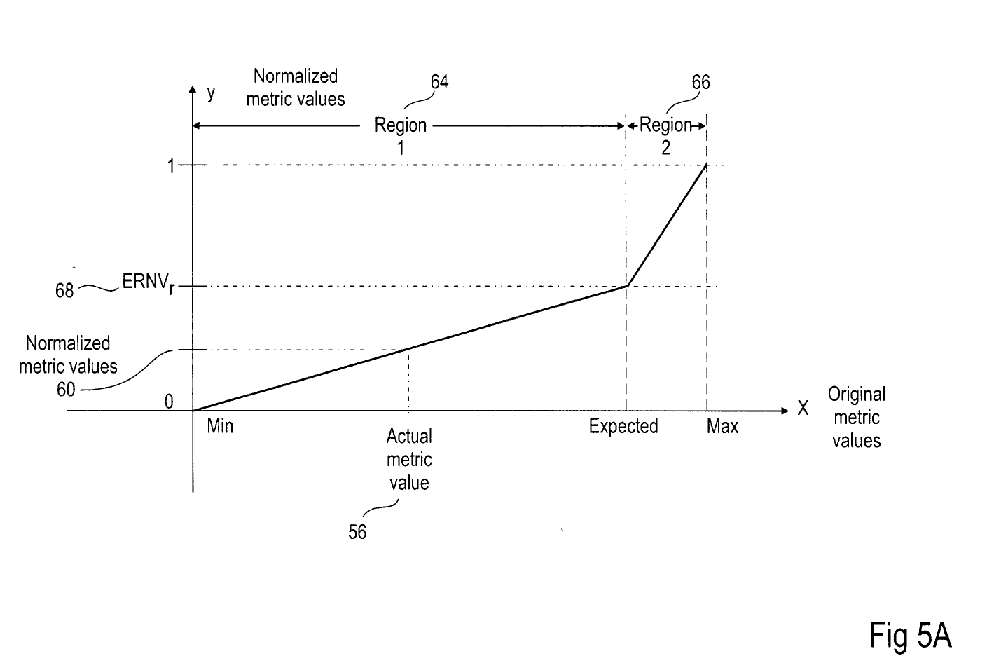

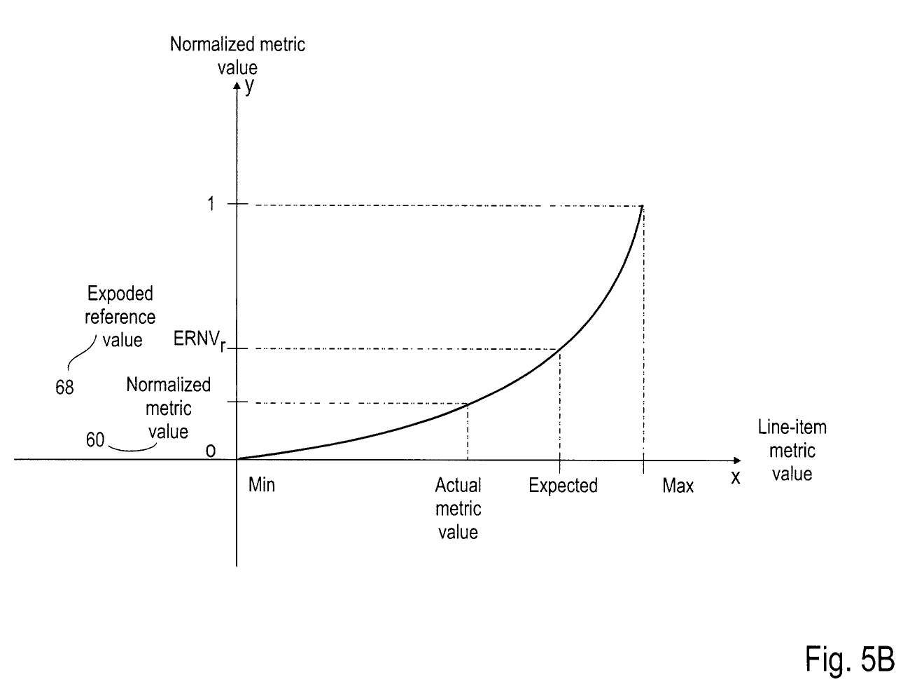

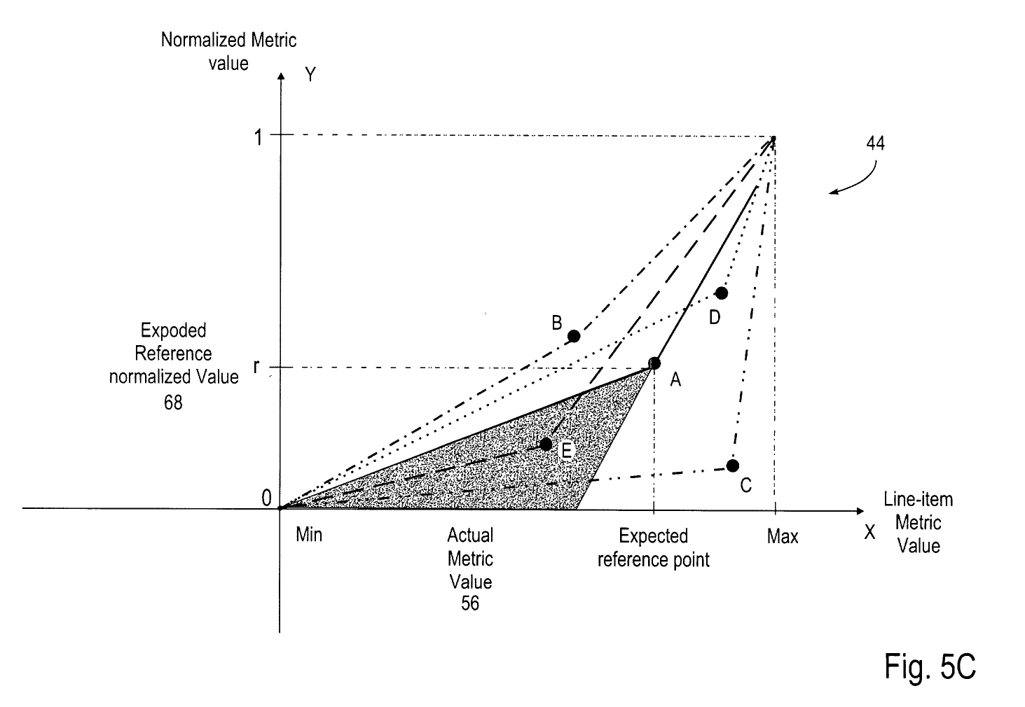

FIGS. 5A-5B illustrate examples of normalizing functions 44 that may be utilized to derive normalized metric values 60 from original line item metric values 56. Turning first to FIG. 5A, the function is expressed as a graph with original line item metric values 56 being depicted on the X-axis and normalized metric values 60 being depicted on the Y-axis. The normalizing function 44 defines two linear regions, namely a first linear region 64 and a second linear region 66. The minimum reference point (or value) for the actual metric value 56 is shown to correspond to a 0 normalized metric value, the original maximum reference value is shown to correspond to a normalized metric value of 1, and the expected reference point (or value) generates a expected reference normalized value (ERNV) “r” 68. Utilizing the normalization function illustrated in FIG. 5A, the actual metric value 56 may be utilized to generate a normalized metric value 60. In short, when the actual metric value 56 is not at one of the reference values, the normalized metric value is defined by the normalized metric function, which may be monotonically increasing or decreasing, but otherwise of any arbitrary shape. The shape of the normalizing function determines the rate at which the normalized metric value changes as the actual metric value 56 deviates from the expected reference point (or value). For the normalizing function illustrated in FIG. 5A, the normalized metric value 60 increases at a relatively slow rate within region 1 and then, after exceeding the expected reference value, increases at a faster rate until the maximum reference value is reached. Both region 1 and region 2 are shown to exhibit linear rates of increase for normalized metric value 60 as the actual metric value 56 increases

FIG. 5B illustrates an example of a smooth normalizing function 44, that may be expressed as a quadratic function further based on three reference values (e.g., the minimum, expected and maximum reference values discussed above).

FIG. 5C illustrates a dynamic normalizing function 44, wherein the normalizing function 44 is dynamically modified and responsive to pre-defined criteria. In the illustrated example, it is noted that the expected reference point (target) (A) may vary according to the value of a line item attribute that constitutes a target modifier. For example, target point A may be modified to E, thereby changing the structure of the normalizing metric function. A further discussion regarding target modifiers is provided below. Examples of line item attributes 24 that constitute target modifiers are lead time and unit volume, which can be set to result in different expected reference values for a particular metric value (e.g., margin, discount), depending upon metric value for the “target” modifier line item attribute.

The present invention also envisages that a normalizing function 44 may dynamically vary based on other inputs, such as date, inventory levels, promotions, etc. For example, an acceptable price for a particular line item may vary as an end of a quarter approaches and sales targets need to be met. In this case, the expected reference value for a margin metric may vary over time, dependent upon the date. The shape of a normalizing function 44 may also vary over time dynamically to reflect changes in product strategy and other business decisions.

In summary, the present invention contemplates both dynamic reference values for particular metric, and also dynamic normalizing functions 44. Changing the value of the expected reference normalized value “r” 68 may be performed as an alternative to changing the price to get to the desired score. Changing the value of the expected (target) reference normalized value “r” 68 may or may not have the effect of changing the shape of the normalizing function 44, although such a change in the shape of the normalizing function 44 will typically result where the normalizing function 44 is linear, as illustrated in FIG. 5C, with different rates of increase for the normalized metric value occurring before and after the expected (target) reference value. Changing the value of the expected reference normalized value “r” 68 may also have the effect of increasing or decreasing an actual normalized metric value 60, which may result in a tightening or loosening of terms and conditions associated with a transaction request 20, as will be appreciated from the discussion below. For example, increasing the expected reference normalized value “r” 68 may be undertaken for a transaction request that relates to items that are in scarce supply, and for which there is accordingly a greater demand. Alternatively, the expected reference normalized value “r” 68 may be decreased for perishable items, or items that are in ample supply, so as to allow the expected reference normalized value “r” 68 to be obtained under less stringent terms and conditions.

With respect to dynamic normalizing functions 44, the minimum and maximum reference values for a particular metric may also be dynamically set to reflect the value of items. For example, the maximum reference value may be set to have a corresponding normalized metric value of less than 1. The object of such reference value modifications is to reflect relative line item values for alternative line item objects that may be included within a transaction request 20. For example, for a given set of attributes for line items objects of the transaction request 20, more desirable line item objects may, utilizing dynamic normalizing functions 44, be attributed higher line item scores.

A normalizing function 44 may also exhibit different characteristics on either side of a target reference value. For example, when plotted on a graph such as those illustrated in FIG. 5A, the normalizing function 44 may exhibit a convex curve for values, having a higher rate of increase (slope) above the target reference value that for below the target reference value. Similarly, the normalizing function 44 can exhibit a concave curve where the slope above the target is lower than the slope below the target. It is also envisaged that the concave and convex curves of a normalizing function may dynamically vary over time, or according to the input of some other variable.

Where a normalizing function 44 is considered to be defined in terms of a number of reference values associated with a particular metric, the calculation of a normalized metric value 68 may involve determining whether a specific metric value 56 corresponds to any one of a number of defined reference values. If so, then the defined reference value to which the specific metric value 56 corresponds is set as the normalized metric value. Alternatively, if the specific metric value 56 is not corresponding to a defined reference value, the normalizing function 44 may interpolate or extrapolate from the set of defined reference values to calculate a normalized metric value corresponding to the specific metric value 56. For example, this may involve interpolating or extrapolating utilizing a convex or a concave function between any two of the defined reference values.

FIG. 4D illustrates examples of normalized metric values 60 that may be generated by multiple normalizing functions 44, based on the metric values 56 shown in FIG. 4C. It will accordingly be appreciated that the normalized metric values 60 represents values, derived according to different metric functions (or measures) that may be compared in a meaningful manner.

Returning now to FIG. 3, following the generation of the normalized line item metric values 60, a line item metric aggregator 46 operates to aggregate the normalized line item metric value 60 for each line item object 28 into a single line item score 70. In one embodiment, each line item score 70 is the weighted sum of normalized metric values 60 for each line item object, which is calculated according to the following equation:

$${S}_{l} = {\sum }_{i = l}^{M} {v}_{i} \cdot N {M}_{i}$$

where, Sₗ is the weighted sum of the normalized metric values for the line item object;

NMᵢ is the normalized metric value for each object; and

νᵢ is a weight assigned to each metric value. The weight νᵢ assigned to each normalized metric value may be user inputted, via an interface.

FIG. 4E illustrates examples of line item scores 70 that may be generated for each of the products included within the original line item object 28, shown in FIG. 4A.

Returning again to FIG. 3, a score aggregator 48 operates to aggregate the line item scores 70, and optionally the normalized request-level metric value 72, to generate the request score 13. In one embodiment, the aggregated score may be computed according to the following formula:

$${S}_{LI} = {\sum }_{i = l}^{n} {U}_{i} \cdot {S}_{l i} ,$$

where S_{LI} is the aggregate score for all line item objects 28;

Sₗᵢ is the line item score 70 for each line item object 28; and

Uᵢ is a weight attached to the relevant line item object to indicate a relative importance to the line item object 28.

For example, the coefficient Uᵢ may be set based on a relative dollar volume of the line item objects 28 within a transaction request 20. In another example, the coefficient Uᵢ for each line item object 28 may be calculated as the normalized product of a target price, Tₚᵢ, and unit quantity, nᵢ, according to the following formula:

$${U}_{i} = \frac{{T}_{p i} \cdot {n}_{i}}{{\sum }_{i = l}^{N} {T}_{p i} \cdot {n}_{i}}$$

The score aggregator 48 may also aggregate the normalized request-level score value 72 (or request-level scores) with the aggregate score for the line item objects 28, thereby to generate the request score 13.

Having calculated the aggregate score for all line item object 28, in one embodiment, the score aggregator 48 may and calculate the request score 13 as a weighted sum according to the following formula:

S=W·Sₗᵢ+(1−W)·S_{RL}

where S is the request score 13;

Sₗᵢ is the aggregate score for all line item objects; and

S_{RL} is a combined request-level attribute score; and

W is a weight attributed to the aggregate line item score.

The calculation of a combined request-level attribute score (S_{RL}) warrants further discussion. In one embodiment, the request-level attributes are discrete, and each request-level attribute value 52 is potentially associated with a change in the request score 13. The below table provides examples of request-level attributes and request-level attribute values 52, and an exemplary score impact.

TABLE 1

| | Level 1 | | Level 2 | | Level 3 | |
|---|---|---|---|---|---|---|
| Request Level | | Score | | Score | | Score |
| attribute | Value | impact | Value | impact | Value | impact |
| Customer | Tier 1 | 5 | Tier 2 | 2 | Tier 3 | 0 |
| Revenue | Tier 1 | 7 | Tier 2 | 3 | Tier 3 | 1 |
| pressure | | | | | | |
| Dollar volume | $10M | 6 | $1M | 2 | $100K | 1 |

Where a single request-level attribute is utilized, the score impact of its level is the value of S_{RL}1, and its contribution to the request score 13 is computed as described, for example, in the above formula.

Where multiple request-level attributes are considered in the calculation of request score, the calculation of the combined request-level attribute S_{RL} may be performed in a number of manners, two examples of which are discussed below. For example, where an additive impact method if used, the combined request-level attribute Sᵣₗ equals the sum of the score impacts of the relevant request-level attributes at their respective values. In the second embodiment, the combined request-level attribute score S_{RL} is computed based on a set of decision rules. Examples of such decision rules include calculating S_{RL} as (1) the maximum of the score impacts over all request-level attribute values, (2) the weighted average of the score impacts, and (3) the sum of the score impacts up to a predetermined maximum score impact.

It will be appreciated that the above example, where the aggregations performed by the line item metric aggregator 46 and the score aggregator 48 are performed by a weighted summing of values, provides only one example of a manner in which values may be aggregated. In different embodiments of the present invention, it is envisaged that aggregation performed by the aggregators 46 and 48 may include different forms of aggregation, including linear combination; a weighted average of hierarchical scores of children object and children object sets where the transaction request 20 includes a hierarchical arrangement of objects; and the selection of any minimum or maximum normalized metric values (or scores).

According to different embodiments of the present invention, aggregation performed by the aggregators 46 and 48 may operate at multiple levels. For example, aggregation may operate at the level of normalized metric values (or scores) for an individual object (as is the example above); at the level of normalized metrics computed for multiple objects (e.g., when a metric value is calculated based on values from across a range of objects), and at the level of hierarchical metric values for children objects combined to form a parent score.

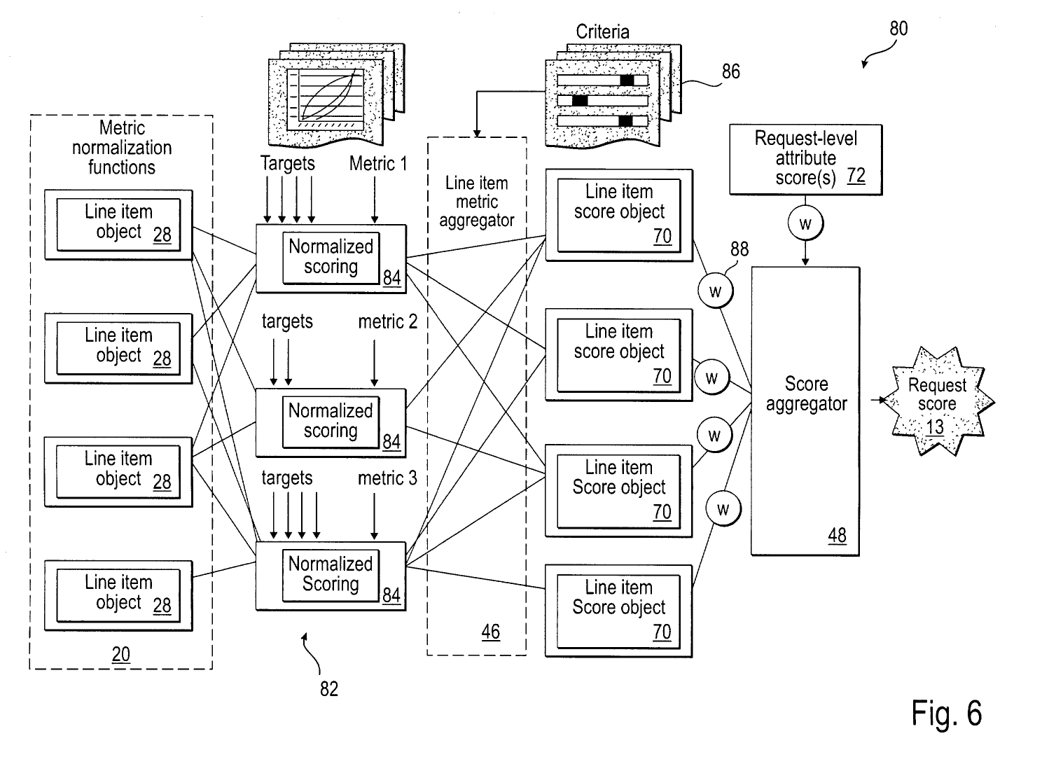

FIG. 6 is a diagrammatic representation of a transaction request evaluation 80, according to one embodiment of the present invention, to illustrate the utilization of different attribute values from different line item objects 28, by a collection 82 of metric and normalizing functions 42 and 44 that each implement a normalized scoring process 84. FIG. 6 illustrates that a different set of targets (or expected reference points or values) provides input to each of the normalized scoring processes 84, each target being associated with a respective line item object 28 that provides input into the respective normalized scoring process 84.

FIG. 6 also illustrates the line item metric aggregator 46 operating to aggregate the outputs of the normalized scoring processes 84 (e.g., the normalized metric values 60) for each line item object 28 into a respective line item score 70. The generation of the line item scores 70 is also shown to take cognizance of criteria 86, which may attribute different weights or priority indications to select normalized metric values 60. FIG. 6 also illustrates that the aggregation of the line item scores 70 by the score aggregator 48 to generate an aggregated line item score. The score aggregator 48 may attach varying weights 88 to different line item scores 70, depending on a relative importance of a line item object 28. The score aggregator 48 is also shown to receive request-level attribute scores 72, which may be combined, as described above, with the aggregated line item score to generate the request score 13. As shown, each of the request-level attribute scores 72 may, in one embodiment, be attributed a weight that is considered by the score aggregator 48 when combining request-level scores 72 and line item score 70 to generate the request score 13.

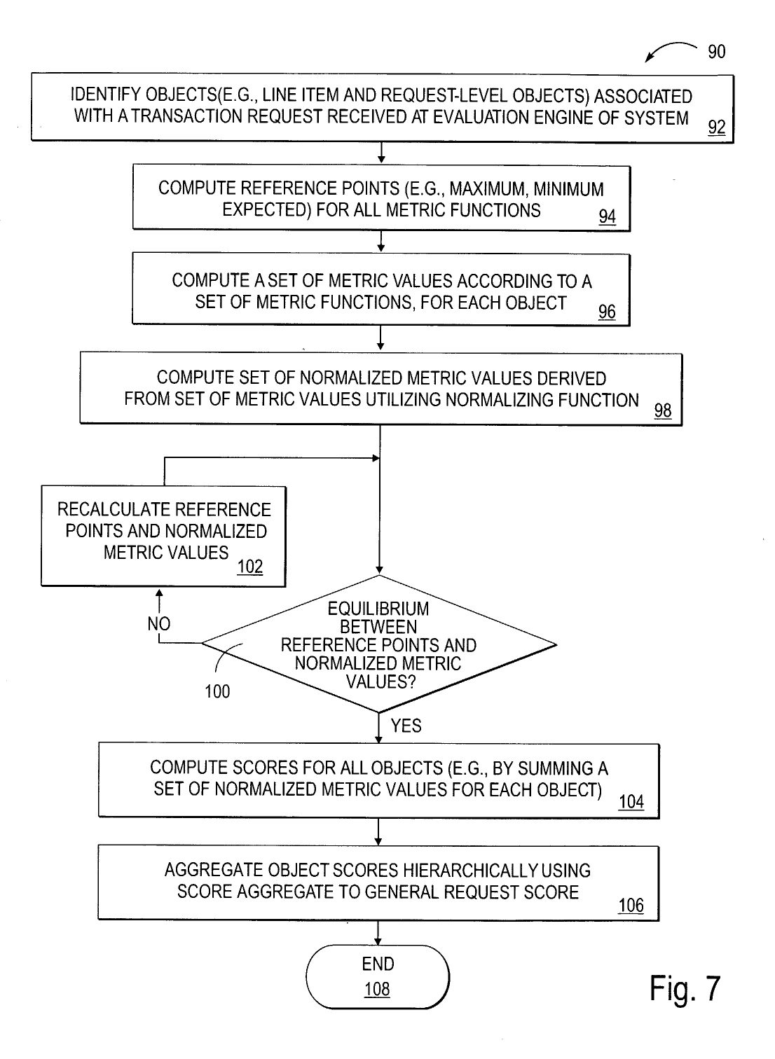

FIG. 7 is a flow chart illustrating a method 90, according to an exemplary embodiment of the present invention, of evaluating a transaction request 20. The flow chart shown in FIG. 7 provides further details regarding the evaluation processes described above with reference to FIGS. 3 and 6.

It will furthermore be noted that the method 90 is iterative and a request score 13 may be computed in multiple iterations, due to interdependencies among the metrics, attributes and reference values. In an alternative embodiment, the computation of a request score 13 may be performed in a single iteration by a sequential computation.

The method 90 commences at block 92 with the identification of objects (e.g., line item and request-level objects 28 and 26) associated with an original transaction request 20 received at the evaluation engine 12 of the evaluation and response system 10. The objects can be in an arbitrary format where the values for metric calculations are identifiable. For example, values can be preceded by a header that declares the nature of these values. The method of metric calculation can be pre-determined or embedded in the object.

As described above, following the identification of the objects, information embodied within the original transaction request 20 may be supplemented by enterprise data 18. For example, at a request-level, customer tier and financing terms information may be associated with the original transaction request 20 based on a customer identifier.

At block 94, a set of reference values is computed for each metric function to be utilized in an evaluation of the transaction request 20. An operator of the system 10 may select the metric functions whereby the transaction request 20 is evaluated. The set of reference values include, for example, the maximum, minimum, expected and zero reference values discussed above. In one embodiment, the set of reference values include a target value that may be manufactured by a user, determined based on historical data, or determined based on sales forecasts and goals.

Line item objects should contain expected attributes and reference points, which are utilized by the metric functions. When some attributes or reference points are missing, it may not be possible to calculate the respective metrics. For example, if the list price is not available for a line item object, the discount metric cannot be calculated. In such cases the evaluation engine 12 computes line item object scores based on the metrics that can be calculated. The aggregation is adjusted accordingly to by computing the weights of the different metrics based on the metrics that can be computed. In one embodiment some attributes may be designated as “mandatory”; a line item object score cannot be computed if a mandatory attribute is missing.

At block 96, a set of metric values (e.g., line item values 56 and request-level metric values 58) is calculated utilizing metric functions 42.

At block 98, a set of normalized metric values 60, derived from the set of metric values, are calculated utilizing the normalizing functions 44.

At decision block 100, a determination is made regarding whether equilibrium has been achieved the set of reference values and normalized metric values 60. If not, at block 102, the reference values and normalized metric values 60 are recalculated, where after the equilibrium determination is again made at decision block 100. The iterative loop including decision block 100 and block 102 is continually performed until equilibrium is reached between the reference values and the normalized metric values 60. Thereafter, at block 104, scores 70 for all objects are computed. In one exemplary embodiment this computation of the line item scores 70 may comprise performing a weighted aggregation of a set of normalized line item metric values 60, utilizing the line item metric aggregator 46, to generate line item scores 70, as described above with reference to FIG. 3.

At block 106, the scores 70 are aggregated hierarchically utilizing a score aggregator (e.g., the score aggregator 48) to generate the request score 13. The method 90 then ends at block 108.

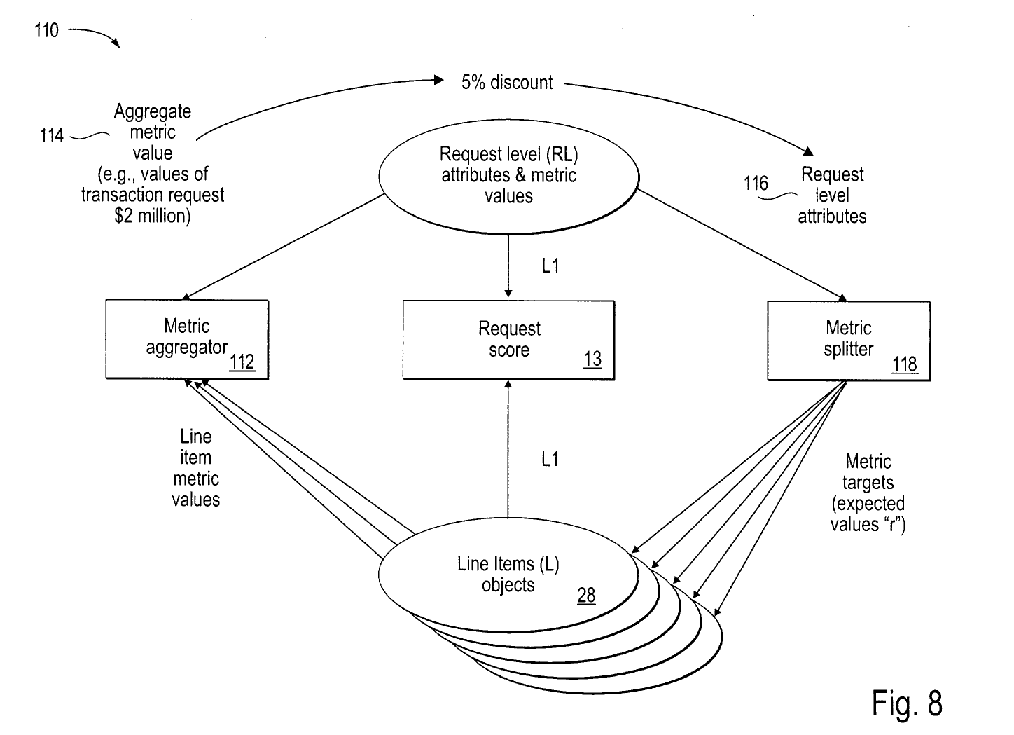

The iterative process whereby equilibrium is obtained between reference values and the normalized metric values 60 as described above with reference to decision block 100 and block 102 warrants further discussion. To this end, FIG. 8 is a diagrammatic representation of an evaluation 110 of dependent metric values in order to achieve equilibrium. In the illustrated example, a metric aggregator 112 generates an aggregate metric value 114. In the exemplary evaluation 110, a number of request-level attribute values 52 and metric values 58 may be dependent upon the aggregate metric value 114. For example, if the aggregate metric value 114 indicates that a total value of the transaction request exceeds a predetermined maximum (e.g., $2,000,000), a discount rule may determine an alternative pricing structure, whereby the list prices of line items are discounted by 5%. The affected request-level attributes 116 (e.g., a list price) are being communicated to a metric splitter 118.

The metric splitter 118, based on the request-level attributes 116, then identifies the attributes of metric functions affected by the modification (e.g., the metric functions affected by 5% discount in the list price), and causes a modification to the appropriate attribute values of the line item objects 28. The updated line item metric values 56 are then again computed and communicated to the metric aggregator 112. It will be appreciated that recalculation of one or more aggregate metric values 114 may again impact the dependent metric functions, and accordingly these dependent metric functions may again need to be recalculated. The aggregate metric values 114 may be based on either request-level or line item attribute values. The above example, however, wherein the aggregate metric value 114 comprises a total price for the transaction request 20, illustrates how dependencies between request-level and line item attribute values are resolved until an equilibrium is reached before the request score 13 is computed.

Considering a categorization of line item attributes into different types can enhance the evaluation of dependent metrics until equilibrium is reached.

Firstly, line item attributes may be categorized as being either (1) metric arguments attributes (e.g., price) within a metric function (e.g., metric functions such as margin and price index are correct functions of price), or (2) target modifier attributes (e.g., lead-time or volume), which set different target values (or expected values “r”) for a metric function.

Secondly, line item attributes may be characterized as being either (1) discrete attributes, which take a finite number of values, or (2) continuous attributes, which take values of an interval.

A target modifier attribute causes a target value change for each (or at least a range of) value for the relevant target modifier attribute. A discussion now follows on the impact of target modifier attributes. As stated above, examples of target modifier attributes include lead-time and volume. For example, a supplier may allow certain discounts of price for lead times or unit volumes above predetermined minimums. Accordingly, a target value for a metric function based on list price would be impacted by a lead-time attribute value associated with a line item object.

Target modifier attributes are discussed below that, for purposes of explanation, are stated to specify a percentage reduction of a target price for a metric. Considering firstly discrete attributes, discrete line item attributes have a finite number of values, wherein each value determines target values for a metric function. Discrete line item attributes include, for example, lead-time, volume and financing terms. Discrete attributes are commonly specified with an impact on a single metric function (e.g., price for additional discounts allowed for each level of the attributes). An example is a volume-discount table. To maintain consistent scores, other price-dependent metric values need to be recalculated. If target values for metric functions are aligned in price (e.g., the same price achieves the target value for all metric functions), the price adjustment per discrete attribute is applied to metrics. On the other hand, wherein different target values for metric functions are achieved at different prices, the percentage price change specified by the discrete attribute is applied to target prices based on which metrics are calculated.

In the present example, for each metric function, a target price is computed through an inverse function of the target metric. The target modifier discount is computed of price. Examples include:

1. The target STD margin is

$$mpr = 1 - \frac{c}{p} .$$

The price at which the STD margin is at its target is

$${p}_{T} = \frac{c}{1 - m {p}_{T}} .$$

The TM discounts are computed off pr.

2. The target multiplier is

$$m {l}_{T} = \frac{P}{L} ,$$

where L is the list price. The price at which the multiplier is at its target is: p_{T}=L·ml_{T}.

3. The target price index is

$$i n {d}_{T} = \frac{p}{A S P} ,$$

where ASP is the average sale price. The price at which the multiplier is at its target is: p_{T}−ASP·ind_{T}.

Where multiple target modifier attributes are considered concurrently the impact can either be (1) additive/multiplicative or (2) compounded (but not additive). Considering a first situation wherein the impact is additive/multiplicative, the impact of the target modifier attributes is computed in series, where the impact of each target modifier attribute is computed off the target price. The target price is computed utilizing the previous target modifier attributes. That is, the target changes are interpreted as incremental adjustments with respect to the current value of target. For example if lead-time discount specifies a 5% discount when the lead time increases from 4-8 weeks, and the volume discount specifies a 10% discount if volume increases to 100 units, then changing the lead time and volume attributes lead to a first 5% discount, and a 10% discount on top of the 5% discount. In one embodiment, such additive/multiplicative impacts are utilized. Additional constraints may however be applied (e.g., the authorized discount never goes beyond a 25% discount limit).

Considering the second situation where the impact is compounded, the composite impact of all the target modifier attribute values is taken jointly, utilizing pre-determined rules encoded in a table or a decision tree. In the above example, the composite impact of the lead-time and volume attribute values may, for example, be a 12% discount, although individually these attributes provide 5% and 10% discounts.

The advantage of the additive approach is the simplicity of the data representation and computation. The advantage of the compounded approach is its flexibility of composite impact. The complexity of implementing the compound approach increases as the product of the number of target modifier attributes and the number of the values increase.

Scoring of a Multi-Product Transaction Request

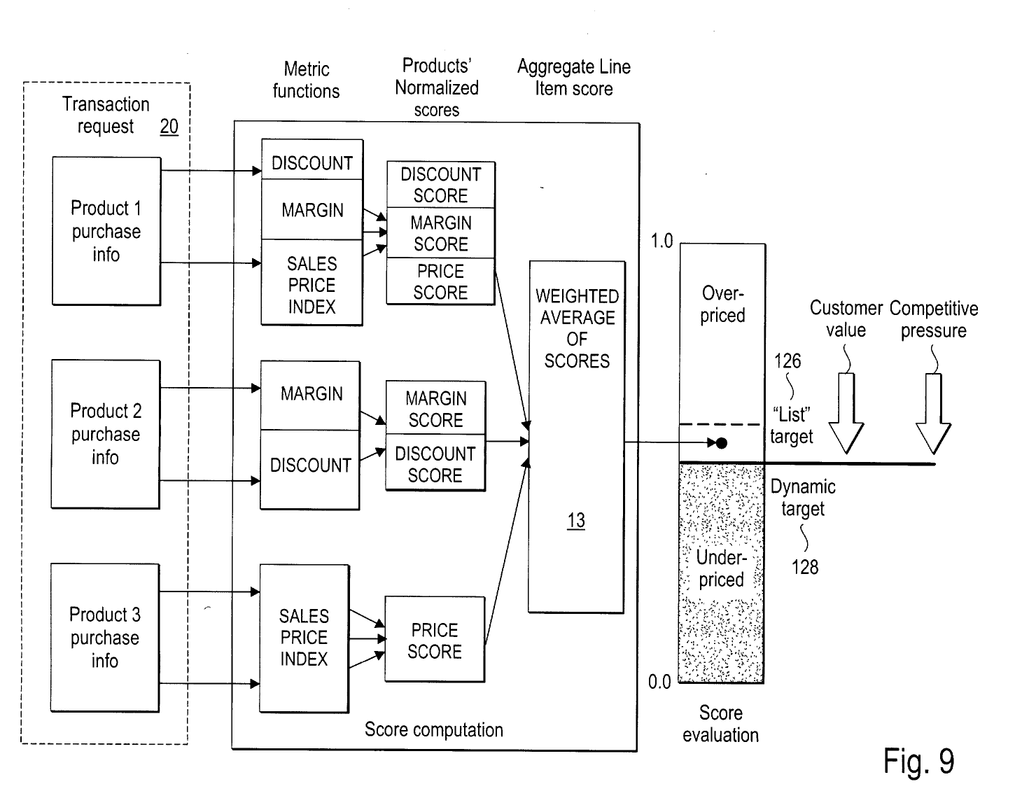

FIG. 9 is a diagram illustrating how the teachings of the present invention may be utilized to generate a request score 13 for a multi-product transaction request 20. It will be appreciated that the present invention may be applied to generate an aggregate line item score that represents the multi-product original transaction request 20, where a particular line item object is an individual product, and a product may further constitute an assembly of a number of subcomponent line items. In this case, a normalized line item score 70 may be generated for the various metrics for each subcomponent line item object or for the product as a whole. In the former case, the normalized line item scores 70 may be combined into a line item score for the assembled line item object.

FIG. 9 also illustrates an evaluation of the request score 13 relative to a “list target” score to which the request score would correspond if catalog (or list) terms and conditions for the product were satisfied by the transaction request 20. FIG. 9 also illustrates an evaluation of the request score 13 relative to a dynamic target 128, which reflects an adjusted target score that is cognitive of other considerations, such as the value of a customer from which the transaction request 20 originated and competitive pressures that may exist within a marketplace for the products to which the transaction request 20 pertains.

Recommendation Engine

FIG. 1 provided a high level discussion of the recommendation engine 14, which is illustrated to embody the comparison process 30 and the modification process 32. The modification process 32 operates to bring a request score 13 into closer a conformity (or correspondence) with a target score for a particular transaction request 20. A further discussion regarding the recommendation engine 14 follows below.

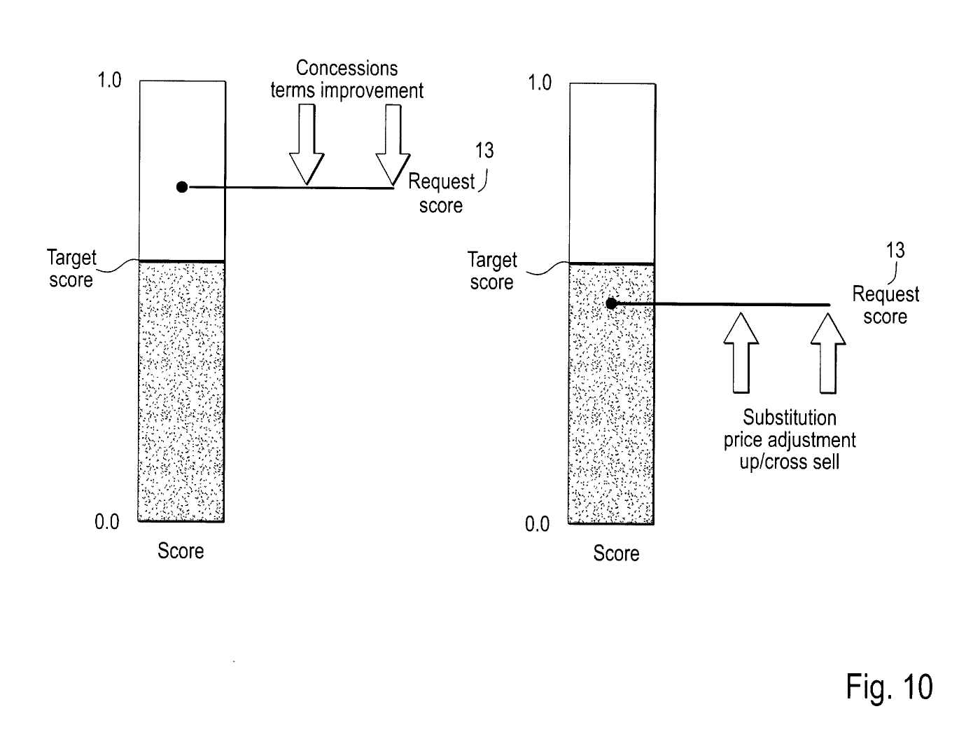

FIG. 10 is a diagram illustrating conceptually how a request score 13 may be adjusted by the recommendation engine 14 to correspond more closely with a target score. For example, if the request score 13 exceeds a target score, modifications (e.g., concessions or term improvements) may be applied to the original transaction request 20 to generate a modified transaction request having a modified request score 13 corresponding to the target score. Of course, a supplier would not necessarily wish to generate a modified request score 13 that exceeds the target score, as this indicates the modified transaction request 20 exceeds predetermined business goals (or business value) specified by the supplier. On the other hand, where the present invention is utilized by a buyer to evaluate a transaction request 20 for communication to a supplier, the buyer is obviously motivated to reduce the request score 13 wherein the transaction request 20 is evaluated to exceed a target score. On the other hand, if the request score 13 falls below the target score, modifications to the transaction request 20 (e.g., substitutions, price adjustments, and up/cross selling adjustments) may be applied by the recommendation engine 14 to the original transaction request 20 to generate one or more modified transaction requests to be communicated from a supplier to buyer as responses 34.

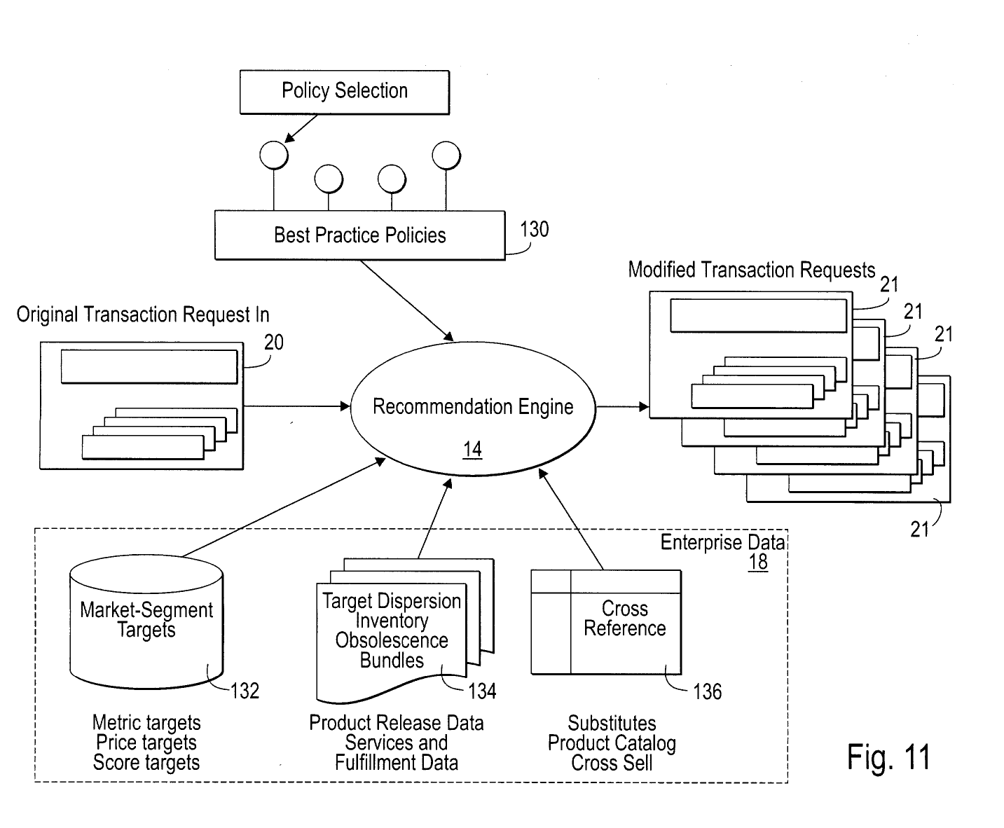

FIG. 11 is a diagrammatic representation of the modification, according to one embodiment of the present invention, by the recommendation engine 14 of an original transaction request 20 to generate a number of modified transaction requests 21. Inputs to the recommendation engine 14 are shown to include enterprise data 18 and best practices policies 130, these inputs being utilized to identify modification opportunities and constraints (or limits) applicable to such modification opportunities, to select between modification opportunities in a manner that is cognizant of business objectives and marketing opportunities, and to perform one or modification actions in response to the selected modification opportunities.

The enterprise data 18 is shown to include market-segment target values 132, which include metric target values, price target values and target score values. The enterprise data 18 also includes products and services data 134, including target dispersion that specifies the modification to targets given different levels of inventory, degrees of obsolescence and products sold in different bundles as specified by the inventory information, obsolescence information, and bundle information. Cross-reference data 136 includes information regarding asset (e.g., product or service) substitutes, product catalog information, and cross-selling information. In one embodiment, information regarding asset substitutions may be included within a substitution table, an example of which will be discussed below.

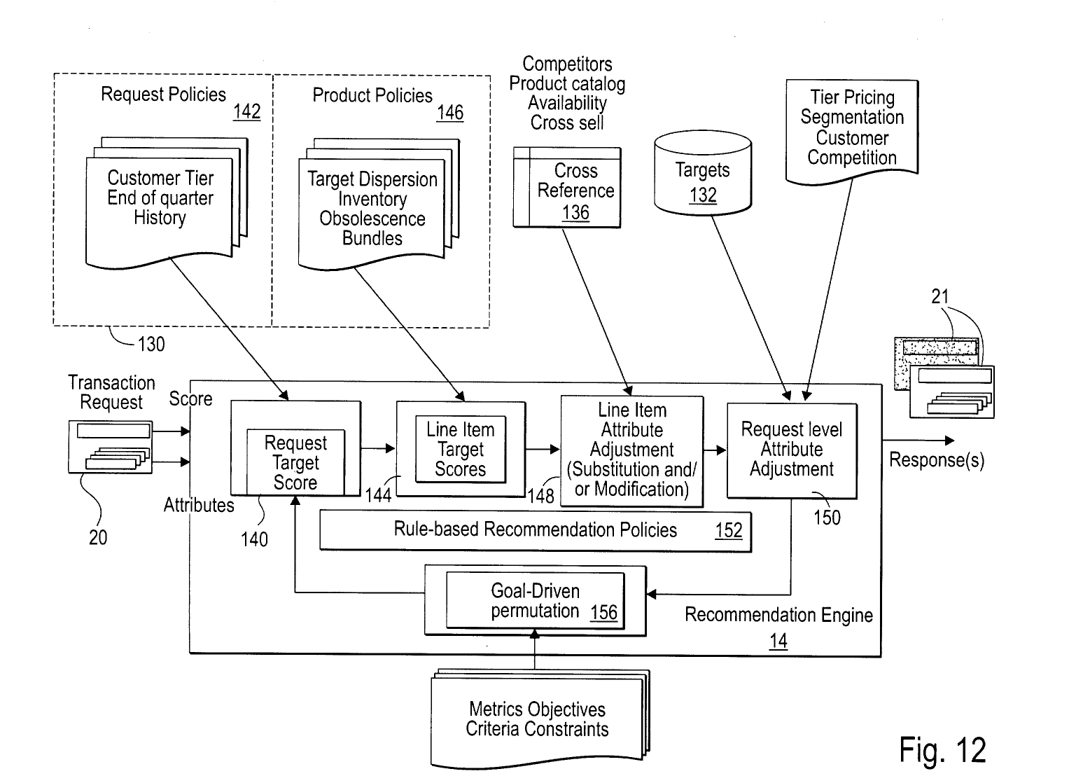

FIG. 12 is a diagrammatic representation, at a high level, of the processes that are performed within the recommendation engine 14. At a first operation 140, a request target score for the transaction request 20, as a whole, is determined. The request target score may be manually inputted by a user of the evaluation and response system 10, or may automatically be calculated based on historical data or on sales forecasts and goals. In one embodiment, the request target score for the transaction request is determined utilizing request policies 142 based on, for example, customer tier, date information (e.g., whether or not the end of quarter is approaching), and a history of interactions/relationships with the relevant customer (e.g., a buyer) from which the transaction request 20 is received.

At a second operation 144, a line item target score is calculated for each of the line item objects 28 within the transaction request 20. As illustrated, product policies 146 may be utilized for the calculation of the line item target scores for each of the line item objects 28. These product policies 146 may utilize the products and services data 134 discussed above.

At a third operation 148, line item (or asset) attribute value adjustments are performed in order to bring the line item scores for each of the line item objects 28 into closer conformity with the line item goal scores (to be discussed in further detail below), in this way to bring the request score into closer conformity with the request target score, calculated at operation 140. The line item attribute value adjustments that may be performed at operation 148 include both attribute modification and attribute substitution operations. More specifically, various alternative options to bring a line item score into conformance with a line item goal score may be identified. Each of these alternative options may be exercised to instantiate a set of alternative attribute values to be included within one of multiple modified transaction requests 21 outputted by the recommendation engine 14. It will also be noted that the cross-reference data 136, discussed above, provides input to the operation 148 so as to facilitate, for example, the identification of substitute line items.

At a fourth operation 150, requests level attribute adjustments are performed in order to bring the request score 13 into closer conformity with the request target score, calculated at operation 140, for the transaction request 20. The target information 132, discussed above, provides input to the request-level attribute adjustment performed at operation 150.

Rule-based recommendation policies 152 are also shown to provide input to each of the operations discussed above. The policies 152 serve as constraints and guidelines to the modifications of line item attributes. An example of recommendation policy is “attain the target score while minimizing the number of line items that are changed.”

Following completion of the fourth operation 150, it will be noted that a goal-driven permutation operation 154 may be performed. This operation affects the order by which line item changes are to be affected and the type of changes that are allowed. The policy can take as an input the number of responses already generated so that every newly generated response is affected by different policies thereby causing the recommendation engine 14 to output different responses.

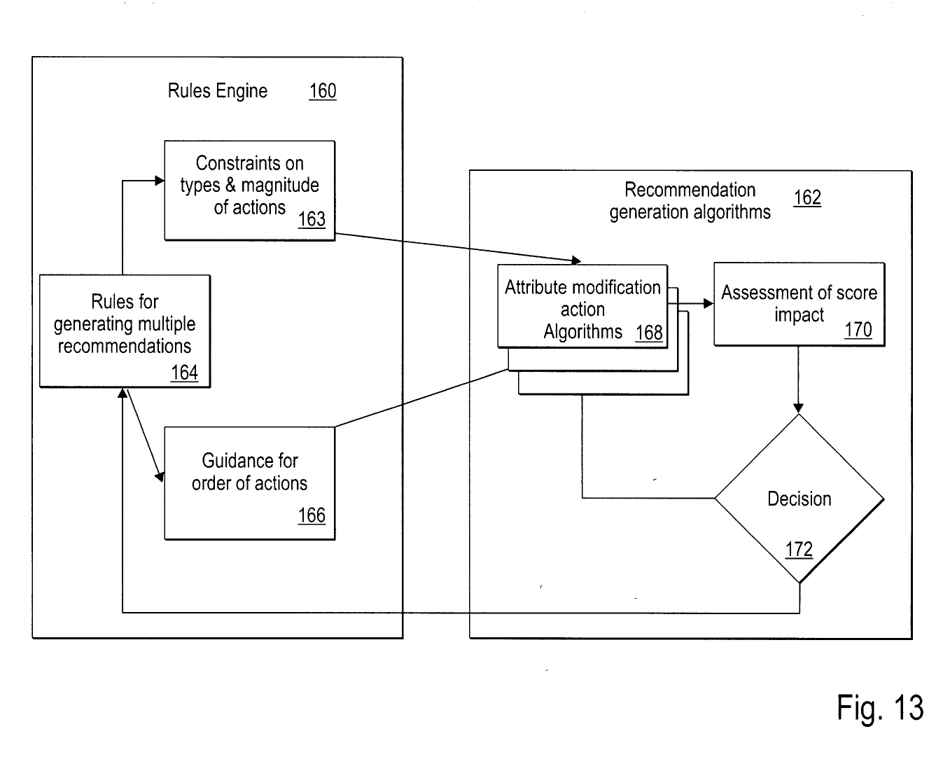

FIG. 13 illustrates that the recommendation engine 14 may conceptually of the viewed as comprising a rules engine 160 and recommendation generation algorithms 162, which interact to generate a one or more modified transaction requests 21 as output. The rules engine 160 is shown to specify constraints 163 on attribute-modification actions that may be performed by the recommendation generation algorithms 162, these constraints pertaining, for example, to a set of attributes to be modified and the types and magnitudes of the modification actions. The constraints 163 are, in turn in, informed by the rules 164 pertaining to the generation of multiple modified transaction requests 21 (or multiple recommendations). The rules 164 also provide input to the guidance 166 pertaining to the order in which modification actions may be performed by the recommendation generation algorithms 162.

The recommendation generation algorithms 162 are shown to include attribute modification action algorithms 168, each of which is responsible for performing one of a set of modification actions as directed by the rules engine 160. An algorithm for assessment of a score impact 170 operates to perform an assessment of a score impact (e.g., the difference between a goal score and an actual line item score for a line item object 28 (or for the transaction request 20 as a whole)). A decision algorithm 172 operates to determine whether a modification action, which resulted in a particular score impact on the score, is sufficient to generate a satisfactory result, and (1) whether further attribute modification actions are required from the attribute modification action algorithms 168 and/or (2) whether the generation of further modified transaction requests 21 (or recommendations) is warranted.

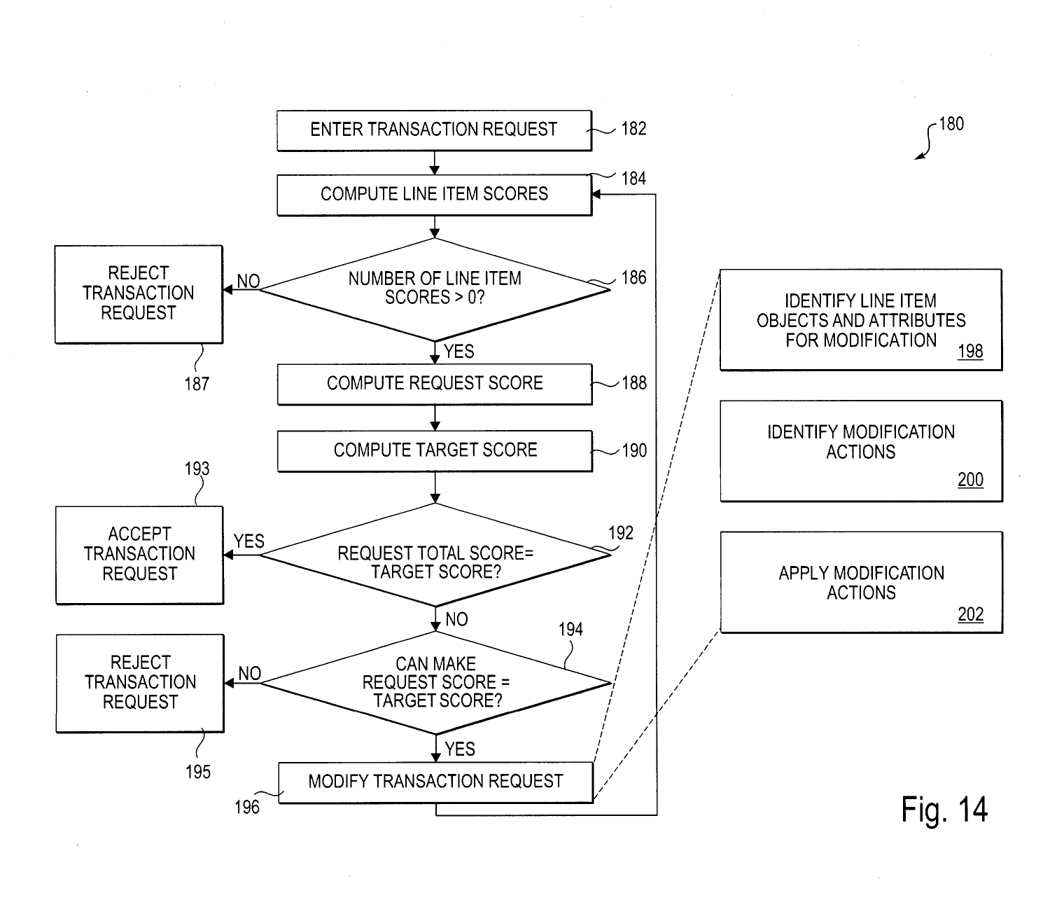

FIG. 14 is a flowchart illustrating an automated method 180, according to an exemplary embodiment of the present invention, of generating a response to a transaction request (e.g., a RFQ). The method 180 commences at block 182 with the entry of a transaction request 20 into the evaluation and response system 10. More specifically, for the purposes of FIG. 14, the transaction request 20 is received at the recommendation engine 14, where the recommendation generation algorithms 162 and rules engine 160 are invoked in order to generate a response to the transaction request 20.

At block 184, respective line item scores 70, for each of the line item objects 28 included within the transaction request 20, are calculated. The line item scores 70 may be calculated in the manner described above, for example, with reference to FIG. 3. At decision block 186, a determination is made as to whether the number of line item scores is greater than 0. If not, the transaction request 20 is rejected at block 187 as this indicates that the relevant transaction request 20 includes no line item objects 28 that may be modified in order to generate the response.

Assuming a positive determination at decision block 186, at block 188, a request score 13 for the transaction request 20 is calculated. In one embodiment, the request score 13 may be calculated in the manner described above with reference to FIG. 3.

At block 190, a target score for the transaction request 20 is computed. In one embodiment, the target score may be manually inputted by a user (e.g., utilizing a user interface generated by the evaluation and response system 10). In another embodiment, the target score may be automatically calculated by the evaluation and response system 10 based on historical data (e.g., the enterprise data 18). In an even further embodiment, the target score may be automatically calculated by the evaluation and response system 10 based on sales forecasts and goals.

At decision block 192, a determination is made as to whether the request score 13, calculated at block 188, equals the target score calculated at block 190. If the outcome of the determination performed at decision block 192 is positive, the transaction request 20 is accepted at block 193. In an alternative embodiment, the determination at decision block 192 may be whether the request score 13 is equal to or exceeds the target score, in which the transaction request 20 may be accepted. The acceptance of the transaction request 20 indicates that the transaction request 20 (e.g., the terms and conditions thereof) meet or exceeds expectations.

If the request score is determined at decision block 192 not to equal the target score, a further determination is made at decision block 194 as to whether modification actions can be performed with respect to the transaction request 20 in order to bring the request score 13 into closer conformity with the target score. This determination may involve assessing whether the request score 13 can be made equal to the target score. If not, the transaction request 20 is rejected at block 195.

Following a positive determination at decision block 194, at block 196 the transaction request 20 is modified in order to generate one or more modified transaction requests 20, each having a respective modified request score that corresponds (or conforms) more closely to, or equals or exceeds, the target score 13. In one exemplary embodiment of the present invention, the modification of the transaction request 20 is, at a high level, shown to include three operations indicated at blocks 198,200 and 202. Specifically, at block 198, the recommendation engine 14 operates to select line item objects 28, and line item attributes 24 embodied within such objects 28, for modification. The selection of the line item objects 28 and line item attributes 24 for potential modification may be performed in accordance with one or more modification policies. Any one of a number of modification policies may be applied in order to identify and select objects 28 and attributes 24 for modification.

At block 200, the recommendation engine 14 then proceeds to identify one or more modification actions that may be applied to the identified object attributes in order to generate the one or more modified transaction requests 21. At block 202, the recommendation engine 14 proceeds to perform the modification actions (e.g., the attribute modification actions 168 embodied within the recommendation generation algorithms 162 shown in FIG. 13). The modification actions may include, for example, line item attribute value modification, line item attribute substitution, line item deletions and/or line item insertions. The modification actions may also include modifying an aggregation method whereby normalized metric values 60, calculated for a specific line item objects 28, are aggregated to generate a line item scores 70. Example for methods for modifying the metric aggregation include (1) changing the weights of the scores of particular metrics, (2) changing the method of aggregation of metric scores of a line item from weighted average to taking one particular score, e.g., the minimum of all metric scores in a line item, (3) taking a certain percentile, e.g., the 25^{th} percentile to constitute the score of the line item. The modification actions may also include a modifying and aggregation method whereby line item scores 70 for multiple line item objects 28 are aggregated to generate the transaction request 13. Examples for methods for modifying the metric aggregation include (1) changing the weights of the scores of particular line items (2) changing the method of aggregation of line item scores from weighted average to taking the one particular score, e.g., the minimum of all metric scores in a line item, (3) taking a certain percentile, e.g., the 25^{th} percentile, to represent the score of all line items.

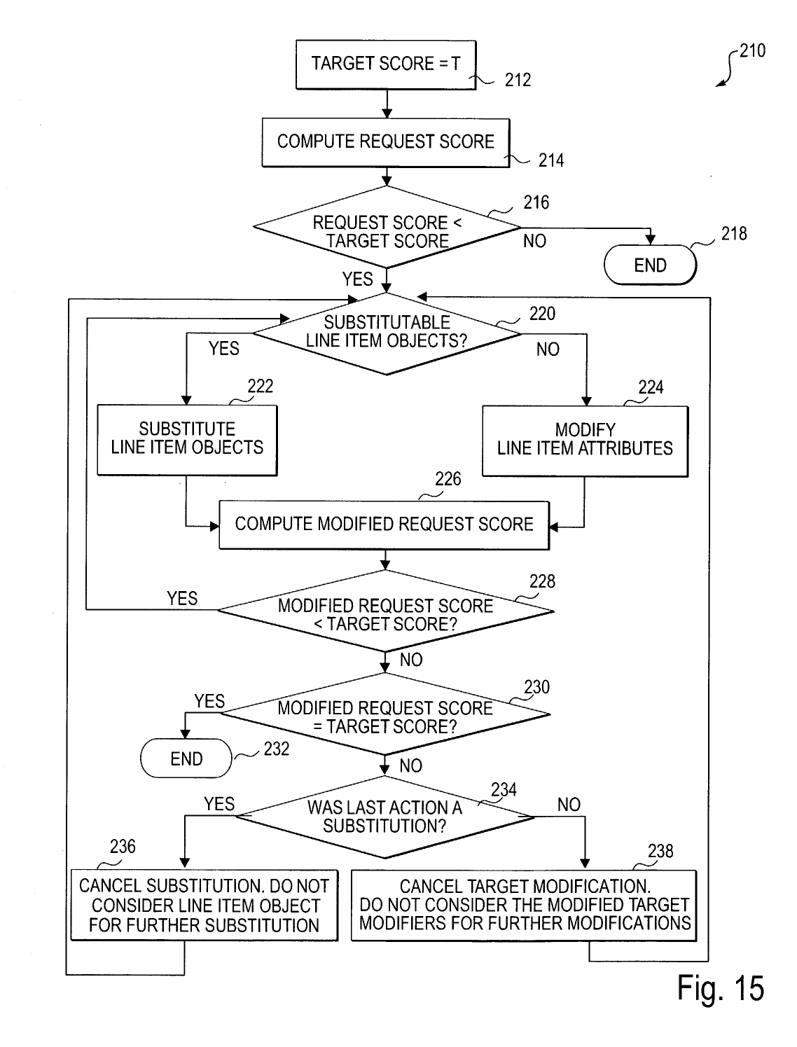

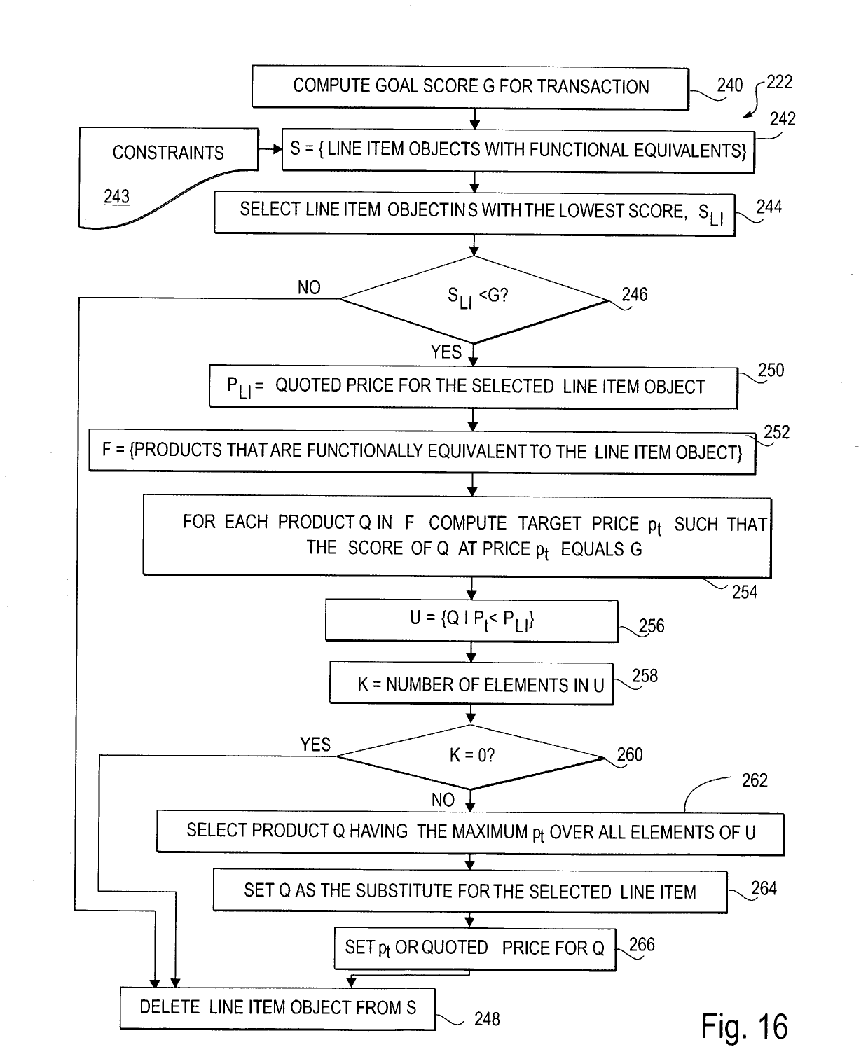

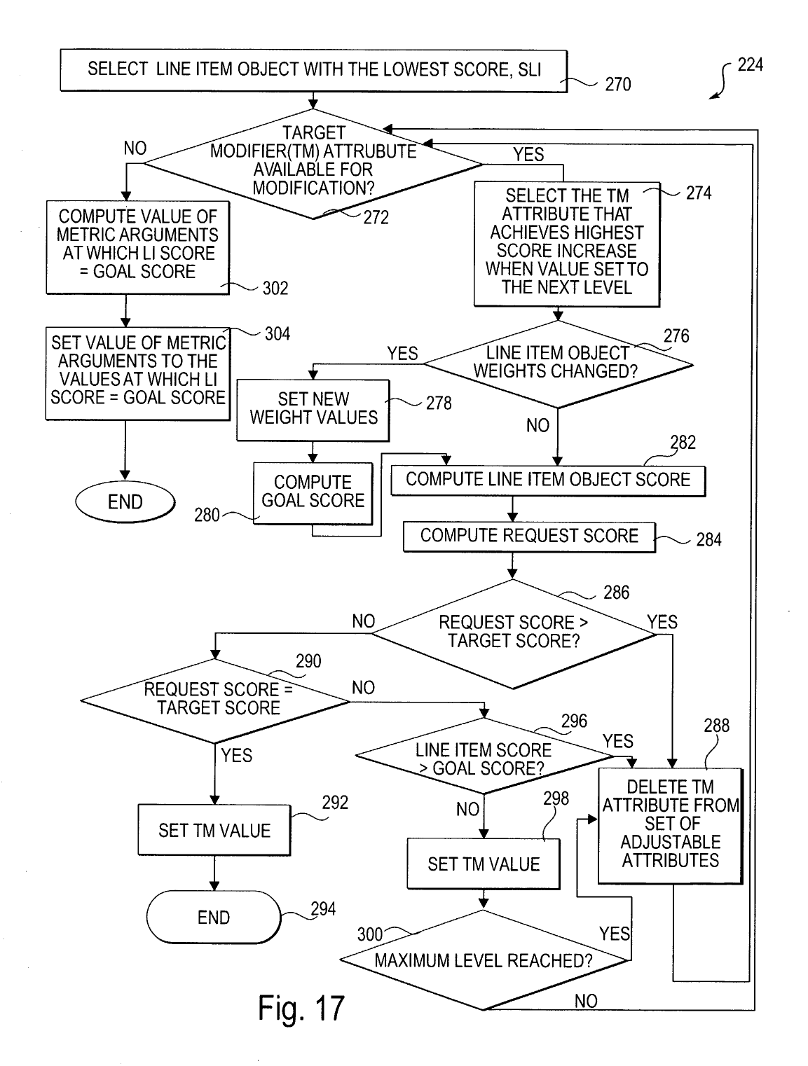

FIG. 15 is a flowchart providing further details regarding a method 210, according to one embodiment of the present invention, of generating one or more modified transaction requests 21 based on an original transaction request 20. The method 210 corresponds somewhat to the method 180 illustrated in FIG. 14, but provides further details regarding a number of operations. Furthermore, the flowchart shown in FIG. 15 illustrates substitution and attribute modification actions regarding which further details are provided in FIGS. 16 and 17.

The method 210 commences at block 212 with the setting of the target score for an original transaction request as equaling a T variable. At block 214, the request score 13 for the original transaction request 20 is computed. At decision block 206, a determination is made as to whether the computed request score 13 is less than the target score. If not (i.e., the request score equals or exceeds the target score), the method 210 terminates at block 218.

Alternatively, should the request score 13 be less than the target score, a determination is made at decision block 220 as to whether the original transaction request 20 includes any line item objects 28 that may be substituted with substitute line item objects. In one embodiment, the determination at decision block 220 is made by referencing a substitution table (not shown) that is included within the enterprise data 18. The substitution table, in one embodiment, provides a mapping of line item objects to substitute line item objects. A typical row in the substitution table contains the identity of an object that can serve as a line item and additional objects that can be substituted for the first object. When the line item is a product, the substitutes are different product with similar functionality. When the line item is a service, the substitutes may be different terms of the same service, e.g., shipment at different dates. Each substitute object contains the value of the target metrics that are to be applies when the substitute object is selected to replace the original object. For example, if the substitute is a different product, and the metric is price, the target metric may be a different price for the substitute product.

If substitutable line item objects 28 are located at decision block 220, the method 210 proceeds to block 222 where one or more of the substitutable line item objects 28 are substituted utilizing substitute line item objects. Further details regarding the substitution operations that may be performed at block 222 are discussed below with reference to FIG. 16. On the other hand, if no substitutable line item objects are located at decision block 222, the method 210 proceeds to block 224 where one or more line item attributes are modified. Further details regarding line item attribute modification operations that may be performed at block 224 are discussed below with reference to FIG. 17.

From block 222 or block 224, the method 210 proceeds to block 226, where a modified request score is calculated for the transaction request as modified by operations performed at block 222 and/or block 224. The determination is then made at decision block 228 as to whether the modified request score is less than the target score. If so, the method 210 loops back to decision block 220 to determine whether any further substitutable line item objects exist within the current transaction request 20.

Alternatively, if the modified request score is not determined to be less than the target score at decision block 228, the method 210 proceeds to decision block 230, where a determination is made whether the modified request score equals the target score. If so, the method 210 ends at block 232. If it is determined at decision block 230 that the modified request score is not equal to the target score (i.e., the modified request score exceeds the target score), a determination is made at decision block 24 whether the last modification action performed (at either block 222 or 224) was a substitution. If so, at block 236, the substitution modification action last performed is canceled, and the line item object 28 that was substituted is disqualified from further consideration for substitution. If the last modification action is determined at decision block 234 not to be a substitution (i.e., to be a line item attribute modification), the line item attribute modification action is reversed, and a target modifier attribute that may have been the subject of the line item attribute modification action is disqualified from further modification actions. The operations performed at blocks 286 and 238 are performed in order to prevent the method 210 from “overshooting” a target score in a manner that may be detrimental to the acceptability of a modified transaction request to a recipient of a response including the modified transaction request.

As will be noted from the decision taken at decision block 222 in FIG. 15, the method 210 attempts to first locate substitutable line item objects 28 within a transaction request 20, and to perform substitution operations pertaining to such substitutable line item objects, before proceeding to identify line item attribute modification opportunities. FIG. 16 is a flowchart illustrating a method 222, according to an exemplary embodiment of the present invention, of performing a line item substitution operation. The method 222 commences with the computation of a goal score “G” for the transaction request 20 at block 240. In various embodiments of the present invention, goal scores may be expressed as request goal scores, pertaining to a request as a whole or at a request level, line item goal scores pertaining to line items, or metric goal scores pertaining to metrics.

The goal score, in the discussed exemplary embodiment, represents a line item score to which the line items scores for all line item objects that fall below the goal score should be raised in order for the modified request score of a modified transaction request 21 to equal (or exceed) the target score for the relevant transaction request 20. Further details regarding an exemplary method by which the goal score may be calculated are provided below.

At block 242, a set “S” of line item objects 28 within the relevant transaction request 20 and having substitute line item objects (e.g., functionally equivalent line item objects) is identified. It will be noted that constraints 243 are applied to identify substitute line item objects. For example, a contract with an originator of the transaction request 20 may specify that only certain line item objects are acceptable substitutes for a particular line item object 28. Other examples for constraints are (1) the maximum level of metric changes allowed in any line item, (2) maximum number of line items in which changes are allowed.

At block 244, the line item object in the set “S” having a lowest line item score (S_{LI}) is selected for consideration. At decision block 246 a determination is made whether the line item score (S_{LI}) for the selected line item object is lower than the computed goal score for the relevant transaction request 20. If not, the selected line item object 28 is deleted from the set “S”, and is accordingly disqualified from further consideration for substitution.

On the other hand, if the line item score (S_{LI}) for the selected line item object is lower than the computed goal score, a quoted price (P_{LI}) for the selected line item object 28 is determined at block 250. The quoted price (P_{LI}) for the selected line item object 28 is determined from the enterprise data 18, and reflects the price that a supplier publishes as the quoted price for the selected line item object 28.

At block 252, a set “F” of substitute line item objects that are substitutable (e.g., functionally equivalent) for the selected line item object 28 is composed. At block 254, for each of the substitute line item objects in the set “F”, a target price (Pₜ) is calculated, such that the line item score for each substitute line item object at the target price (Pₜ) equals the goal score. At block 256, a set “U” of substitute line items for which the target price (Pₜ) is less than the quoted price (P_{LI}) is composed. At block 248, a variable K is set to equal the number of elements in the set “U”.

At decision block 260, a determination is made as to whether the variable K has a value of 0. If so, the selected line item object 28 is again deleted from the set “S” of line item objects 28. Alternatively, if the set “U” is not empty (i.e., K is not equal to zero), at block 262 the substitute line item within the set “U” having a maximum target price (Pₜ) is selected and, at block 264, the selected substitute line item object is set as a substitute for the selected line item object. At block 266, the target price (Pₜ) of the selected substitute line item object is set as the quoted price (P_{LI}) for the selected substitute line item object. The selected line item object is then, at block 248, deleted from the set “S” of line item objects.

FIG. 17 is a flowchart illustrating a method 224, according to an exemplary embodiment of the present invention, of performing a line item attribute modification operation. As noted from FIG. 15, the method 224 is invoked with respect to a target request 20 when the target request 20 is evaluated to include no further substitutable line item objects at decision block 220.

The method 224 commences at block 270 with a selection of a line item object 28 from line item objects of a transaction request 20 that are available for modification. Specifically, a line item object 28 with a lowest line item score (S_{LI}) is the selected for modification.

At decision block 272, a determination is made as to whether the selected line item object 28 includes a target modifier (TM) line item attribute 50 that is available for modification. If at least one such target modifier line item attribute 50 is available, the method 224 proceeds to block 274 where the target modifier line item attribute 50 that achieves a highest line item score increase is selected. In one embodiment, the selected target modifier line item attribute 50 (the selected attribute 50) that achieves the highest line item score increase where a value for the selected attribute 50 is set to a next level within a predetermined set of value levels. Consider for example that the selected attribute 50 may be a quantity attribute, and that a quantity-discount table (not shown) may specify different discount rates based upon quantity (e.g., a quantity of 50 line items may result in a 10 percent discount, a quantity of 100 line items may result in a 20 percent discount, and a quantity of 1000 line items may result in a 30 percent discount). In this example, the “next level” may comprise the 100 line item quantity level that results in a 20 percent discount, as opposed to a previously determined 10 percent discount.

At block 274, the next level value for the selected attribute 50 is temporarily attributed to the selected attribute 50, in this way to temporarily modify the selected attribute 50 so that the impact of the next level value may be assessed before the next level value is set as a value for the selected attribute 50.

It will be appreciated that the above described manner in which the selected attribute 50 is selected, and whereby a new value is temporarily attributed to the selected attribute 50, is merely one example of a manner in which the selected attribute 50 may be identified and modified. Alternative methods whereby TM attributes are identified and modified include (1) selection of multiple TM and modifying their targets jointly, (2) select the TM attribute that brings the score closes to the target, and (3) consider jointly multiple TM attributes, make individual change in each such attribute, and select the top 2 attributes that brings the score closest to the target.

At decision block 276, it is determined whether the weights associated with the selected line item object have changed in cases where the weights are determined by the values of the metric. For example, if the weight of the a line item is dependent on the total dollar amount associated with the line item, changing the price of the line item and/or the quantity of the object in the line item, the resulting dollar amount change, e.g., the product of item price and quantity, affects the weight of the line item.

If the weights associated with the selected line item object 28 are determined to have changed at decision block 276, at block 278 new weight values are set. An example of how the new weights may be determined is computing the new sum of dollar value of all line items, and dividing each line item dollar value by the sum. The resulting fractions are the new line item weights.

At block 280, a new goal score for the selected line item object 28 is calculated, taking into account the new weight values associated with the line item object 28.

Following completion of the new goal score calculation operation at block 280, or if the weights associated with the selected line item object are determined not to have changed at decision block 276, the method 224 proceeds to block 282, where a line item score 70 for the selected line item object 28 (as modified at block 274) is calculated. At block 284, a modified request score for the modified transaction request 21 is calculated, the modified request score reflecting an impact of the attribute modification operation performed at block 274.

At decision block 286, a determination is made as to whether the modified request score is greater than the target score for the modified transaction request 21. If the modified request score is determined to now exceed the target score, an “overshoot” condition is detected and, at block 288, the selected attribute 50 is disqualified from consideration for modification by removing the selected attribute 50 from a set of adjustable line item attributes of the selected line item object 28. From block 288, the method 224 loops back to the decision block 272, where an assessment is made as to whether any further target modifier attributes are available for modification.

On the other hand, if it is determined at decision block 286 that the modified request score does not exceed the target score, a further determination is made at decision block 290 whether the modified request score equals the target score for the selected line item object 28. If so, at block 292, the next level value, which was temporarily attributed to the selected attribute 50 at block 274, is set as the value for the selected attribute 50. In this way, the selected attribute 50 is modified. The method 224 then ends at block 294.

If, at decision block 290, the modified request score is determined not to equal to the target score (i.e., to be less than the target score) for the selected line item object 28, an assessment is made at decision block 296 whether the line item score 70 for the selected line item object 28 exceeds the goal score for the selected line item object 28. If so, at block 288, the selected attribute 50 is again disqualified from consideration for modification. Alternatively, if the line item score 70 is assessed to be equal to or less than the goal score for the selected line item object 28, at block 298, the next level value is set as the attribute value for the selected attribute 50.

At decision block 300, an assessment is then made as to whether the next level value, set as the attribute value, at block 298 is the maximum level value for the selected attribute 50. Considering the above example, where the selected attribute 50 constitutes a quantity variable, an assessment may be made as to whether the quantity value is greater than 1000 line items (i.e., a maximum level specified in the quantity-discount table). If it is determined that the maximum level value has been attributed to the selected attribute 50, the selected attribute 50 is disqualified from the consideration for modification at block 288. On the other hand, if the maximum level value has not been attributed to the selected attribute 50, the selected attribute 50 should be considered for further potential modification, and is accordingly contained within a pool of attributes considered for modification. Accordingly, following a negative determination at decision block 300, the method 224 loops back to decision block 272.

Returning to decision block 272, following a determination that no further target modifier attributes are available for modification, at block 302, respective values are computed for metric argument line item attributes (metric argument attributes) of the selected line item object 28 at which the line item score equals the goal score for the selected line item object 28. For example, as described above, price may be regarded as a metric argument line item attribute. Accordingly, a value for a price line item attribute may be calculated so that the line item score 70 corresponds to the goal score for the selected line item object 28.

At block 304, one or more values computed at block 302 are set as values for selected metric argument line item attributes. In this way, the line item score is brought into conformity with the goal score for the selected line item object 28.

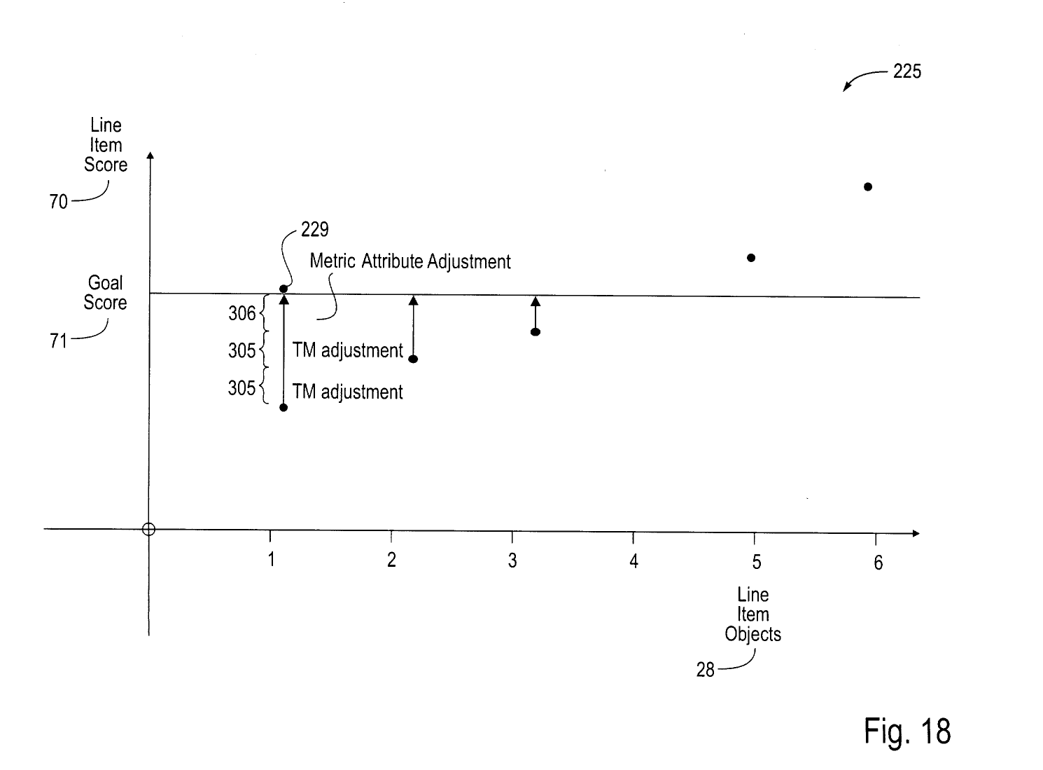

FIG. 18 is a graph 225 providing a graphic depiction of an example in which the method 224 operates to incrementally increase a line item score 70 for a line item object (1) from an original line item score 227 to a modified line item score 229 that corresponds to a goal score 71. The illustrated example shows that two target modifier (TM) attribute modification operations with respect to target modifier attribute values are performed that result in incremental increases 305 of the line item score 70. Following the second increase 305, no further target modifier attributes are identified at decision block 272 for modification, and accordingly a metric attribute adjustment is then performed to effect the increase 306 so that the modified line item score 229 corresponds to the goal score 71.

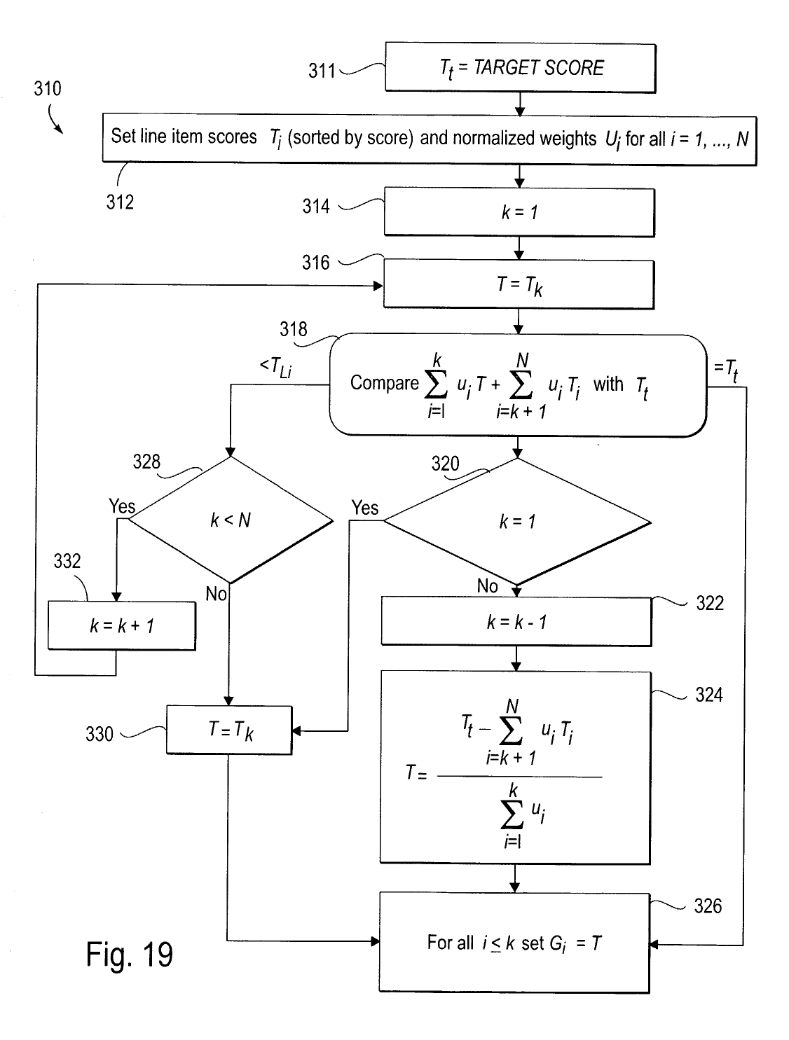

FIG. 19 is a flowchart illustrating a method 310, according to an exemplary embodiment of the present invention, via which a goal score for a line item object 28 of a transaction request 20 may be computed given the target score for the transaction request and the initial scores for each one of the line items. As stated above, in this one embodiment, the goal score is considered to be a line item score to which the line items scores of all line item object 28 of the transaction request 20 that are originally below the goal score should be conformed. When the line item scores are increased to reach the goal score, the aggregate score of the transaction request is equal to the target score for the transaction request 20. In the exemplary method 310, at a high level, the goal score is iteratively computed by considering line item objects 28 in order of the lowest line item score first, raising the line item score for a lowest score line item object 28 to the line item score of the second lowest score line item object 28, and assessing whether the raised line item score results in a request score 13 for the relevant transaction request that is equal to the target score. If, the score of the transaction request is below the target score, the line items scores for the two lowest score line item object 28 are raised to the line item score of the third lowest score line item object 28, and an assessment is again made, and so on. If the score of the transaction request is higher than the target score, the attributes of the line item objects that were increased in the last step, are decreased to reach the target score for the transaction request. FIG. 19 provides further details regarding this method 310. The procedures detailed in FIG. 19 finds the optimal score for each line item, and sets the attributes of each line item object so that the score of the line item equals the goal score.

At block 311 the variable Tₜ is set equal to the target score of the transaction request. At block 312, the line item scores for all line item objects 28 of a transaction request 20 are set as a sorted list of variables (Tᵢ), and normalized weights for the line item objects are set as variables (uᵢ). The sorted list of variables (Tᵢ) is sorted in order of ascending line item score. At block 314, a count variable (k) is set to 1, and an evaluation variable (T) is a set in block 316 to the value of Tₖ.

At block 318, the sum of (a weighted sum of evaluation variable Tₜ) and (a weighted sum of line item object scores k+1 through N) is compared with the target score (Tₜ) for the relevant line item object 28. If the sum is determined to be equal to the target score (i.e., it is evaluated that increasing the object scores for line item objects 1 through k to the line item score of the line item object k achieves the target score), then the goal score is set to equal to the evaluation variable (T) at block 326.

Alternatively, if the sum is determined to be less than the target score, a determination is made at decision block 328 as to whether the count variable is smaller than the number of line item object scores being considered. Following a negative determination, the evaluation variable (T) is set to equal to the target score (Tₖ). Following a positive determination, the count variable (k) is incremented and the method 310 loops back to the block 316.

If, at block 318, the sum is determined to be greater than the target score, a determination is made at decision block 320 as to whether the count variable (k) is equal to 1. If so, the method 310 progresses to block 330. Alternatively, if the count variable (k) is not equal to 1, at block 322, the count variable is decremented by 1. At block 324, the evaluation variable (T) is then calculated to have a value according to the formula indicated in FIG. 19, whereafter the method 310 began progresses to block 326 where the goal scores for the line items with indexes 1 to k are set to the evaluation variable T.

The line item attribute modification operation described above with reference to FIG. 19 is merely one example of a modification policy that may be implemented to select a line item object 28 for modification, and perform a specific modification action. In an alternative embodiment of the present invention, an equal change policy may be implemented whereby the line items-scores of a number of line item objects are modified by an equal amount so that the request score 13 is brought into conformity with a target score. For example, all line item objects having a line item score below the target score may be increased by an equal magnitude.

A plurality of modification policies may further be applied to generate the modified transaction request. These modification policies may be selected by a user from a predetermined set of modification policies, and further applied in an order specified by a user.

In a further embodiment of the present invention, a target score policy may be implemented to bring of the request score 13 into conformance with the target score. The target score policy involves simply adjusting the line item scores for each of the line item objects 28 within a transaction request 20 into conformity with the target score.

User Interfaces

In one embodiment of the present invention, the evaluation and response system 10 operates to present a number of user interfaces to a user in order to communicate information generated by the evaluation and recommendation engines 12 and 14, and to receive input for utilization by the evaluation and recommendation engines 12 and 14 to perform the methodologies described above. To this end, FIG. 1 illustrates the evaluation and response system 10 as including a Web server 15 that is coupled to, and interacts with, both the evaluation engine 12 and the recommendation engine 14. The Web server 15 operates to dynamically generate markup language documents (e.g., HTML documents) that may be computed by a user utilizing a conventional browser.

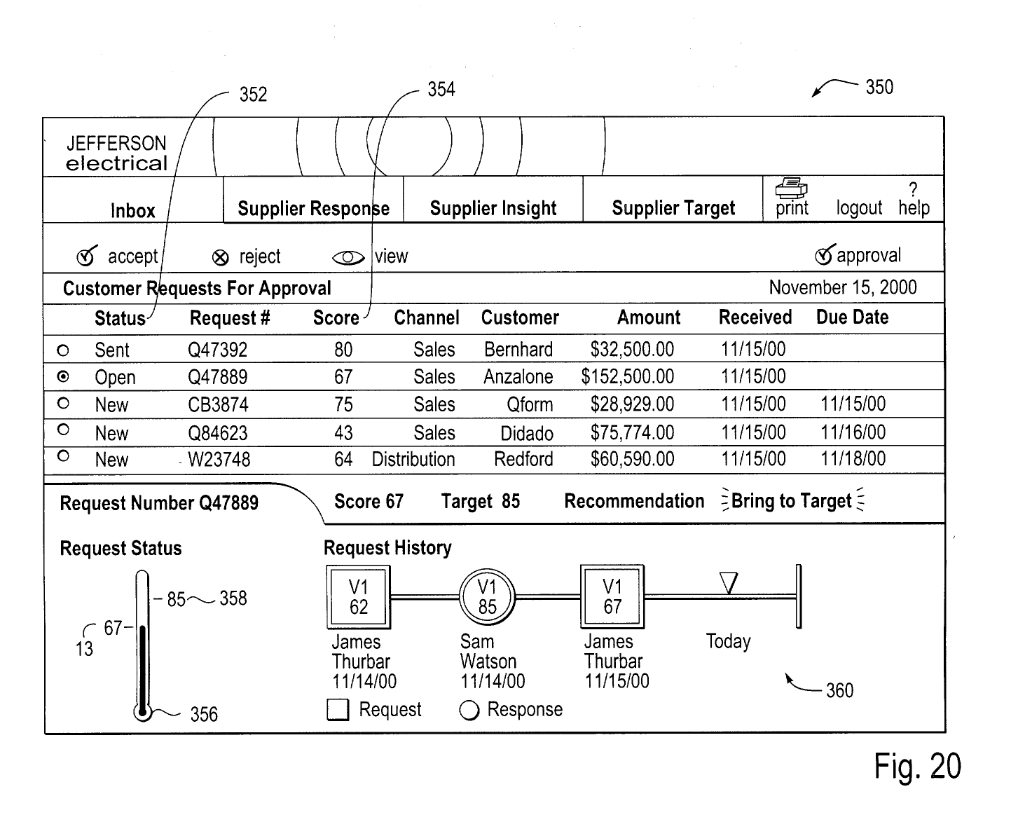

FIGS. 20-33 illustrates a number of exemplary user interfaces, generated by browser utilizing HTML generated by the Web server 15, that facilitate user interaction with the evaluation and response system 10.

FIG. 20 illustrates an exemplary user inbox page 350 that displays to a user outstanding transaction requests 20 that have been received at the evaluation and response system 10. It will be noted that the inbox page 350 displays, inter alia, status information 352 pertaining to each transaction request 20, as well as a request score 354. The lower part of the inbox page 350 displays information for a selected transaction request 20 (e.g., a transaction request 20 that is selected utilizing a radio button in the upper part of the inbox page 350). Specifically, a “thermometer” 356 displays a request score 13 for the selected transaction request relative to the target score 358. A request history 360 summarizes previous cycles of negotiation that may have occurred with respect to the selected transaction request 20. The request history 360 may be generated utilizing the prior negotiation data 36 described above with reference to FIG. 1.

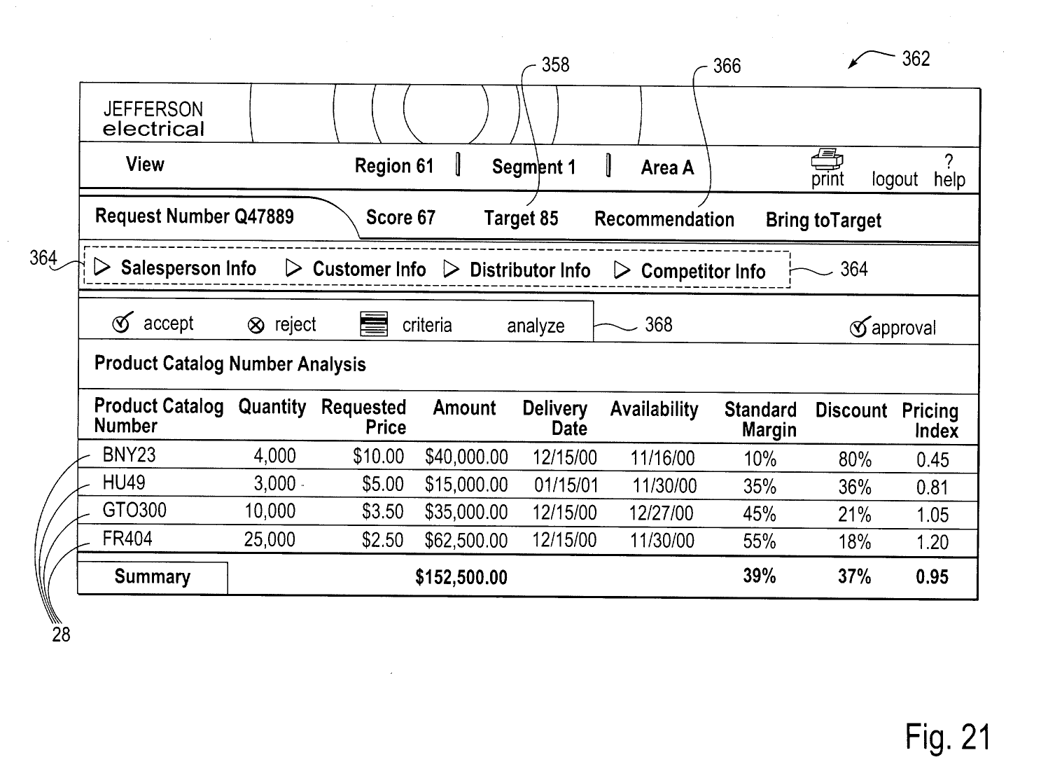

FIG. 21 illustrates an exemplary view page 362 that displays the content of a selected transaction request 20. Specifically, the view page 362 is shown to display line item attribute information (e.g., quantity, requested price, and delivery date) for each line item object 28 included within the selected transaction request 20. In addition, metric values (e.g. dollar amount, product availability, standard margin, discount and pricing index), as computed by the evaluation and response system 10, are displayed for each line item object 28.

The view page 362 also includes links (e.g., hypertext links) 364 to support information (e.g., salesperson information, customer information, distributor information and competitor information) for the selected transaction request 20. The view page 362 also displays both the request score 13 and the target score 358 for the selected transaction request 20. A recommendation 366 provides a recommended action pertaining to the selected transaction request 20 (e.g., “bring to target”).

The view page 362 also includes a number of action buttons 368 that are user-selectable to enable the user to perform a number of actions with respect to the selected transaction request. For example, the user may select an “accept” button to accept a request in its current state, a “reject” button to reject the request without attempting to bring the request score into conformity with the target score, a “criteria” button to display criteria for evaluation metric functions to be applied in the evaluation of the selected transaction request 20, an “analyze” button to modify request attributes and an “approval” button to display approval workflow status.

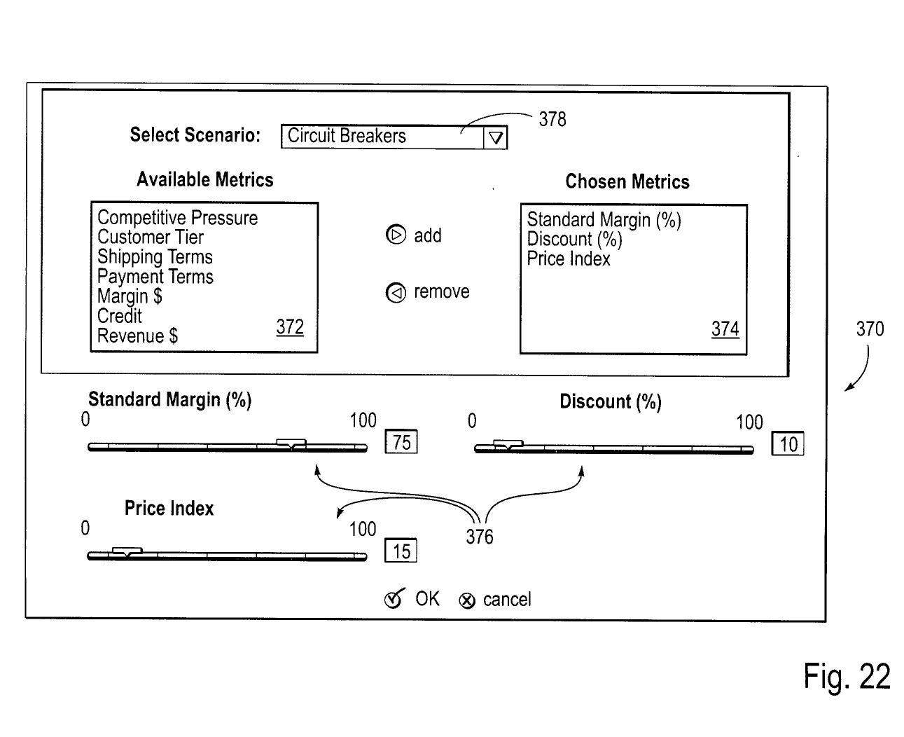

FIG. 22 illustrates an exemplary criteria page 370 that displays, and that allows a user to select, metric functions that may be utilized in the evaluation of a transaction request 20. As illustrated, the criteria page 370 includes an “available metrics” window 372, in which all available metric functions are displayed, and from which user-selected metric functions are transferable to a “chosen metrics” window 374. The criteria page 370 also displays a number of slider bars 376, one slider bar 376 corresponding to each of the chosen metrics functions displayed in the “chosen metrics” window 374. The slider bars 376 are user operable to allow the user to set the relative weights for each of the chosen metric functions. In one embodiment, metric functions and weights can also be assigned as one of a number of predefined complete sets of metric functions and weights (for convenience, termed “scenarios”). Specifically, a user may select a predefined scenario from within the “scenario” box 378, which presents a drop-down menu of predefined scenarios.

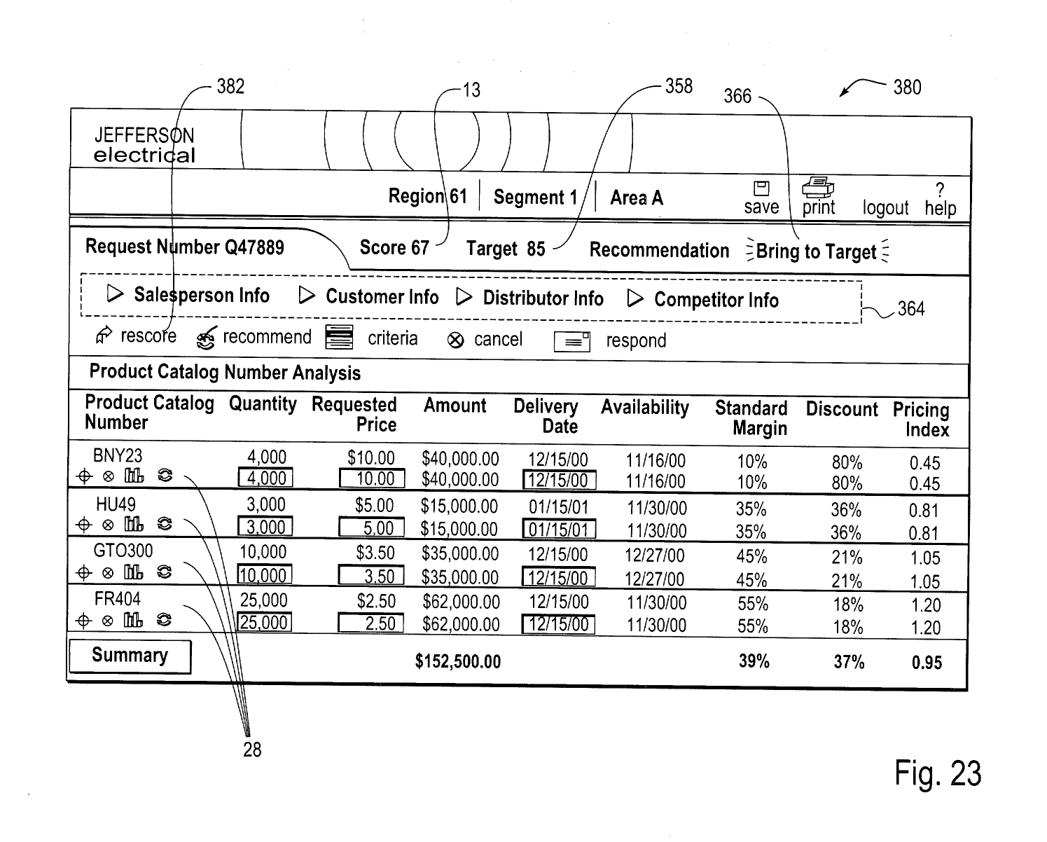

FIG. 23 illustrates an exemplary analyze page 380 that corresponds somewhat to the view page 362 illustrated in FIG. 21, but differs in that allows a user manually to change the values of line item attributes 24, and also that displays modifications and changes that may have been made to line items and attribute values. To this end, a dual line display is presented for each line item, a top line displaying the attribute values as contained in the original request, the lower line displaying attribute values that have been updated, and that can be manually modified by a user. For example, in the illustrated embodiment, the user is presented with the ability to modify the values for the quantity, request price and delivery date line item attributes. Furthermore, user selection of a “rescore” button 382 causes the computed metric values, including the line item metric values and request score 13, to be recalculated by the evaluation and response system 10 to reflect the change in the attribute value.

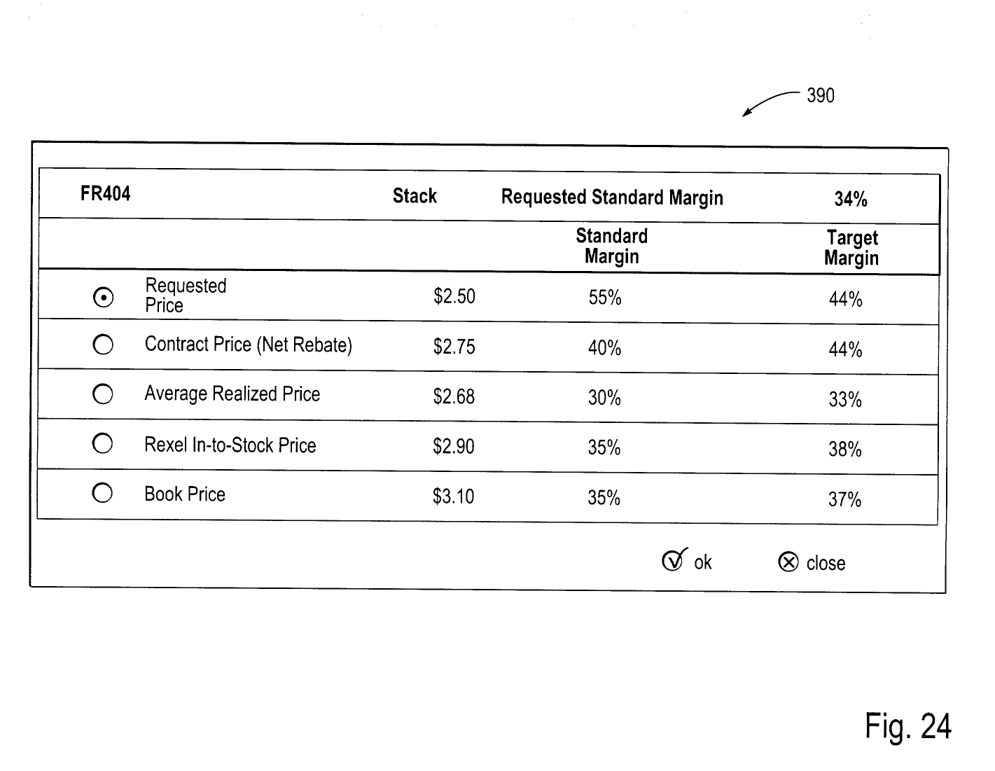

FIG. 24 illustrates an exemplary contract price details page 390 that displays a number of price points for a selected line item object 28. In the exemplary embodiment, the following price points for the selected line item object 28 are displayed: the request price, price as specified in an existing contract of the customer, average price for which the product was sold, distributor price, and book price. The contract price details page 390 also displays a standard margin per the requested price.

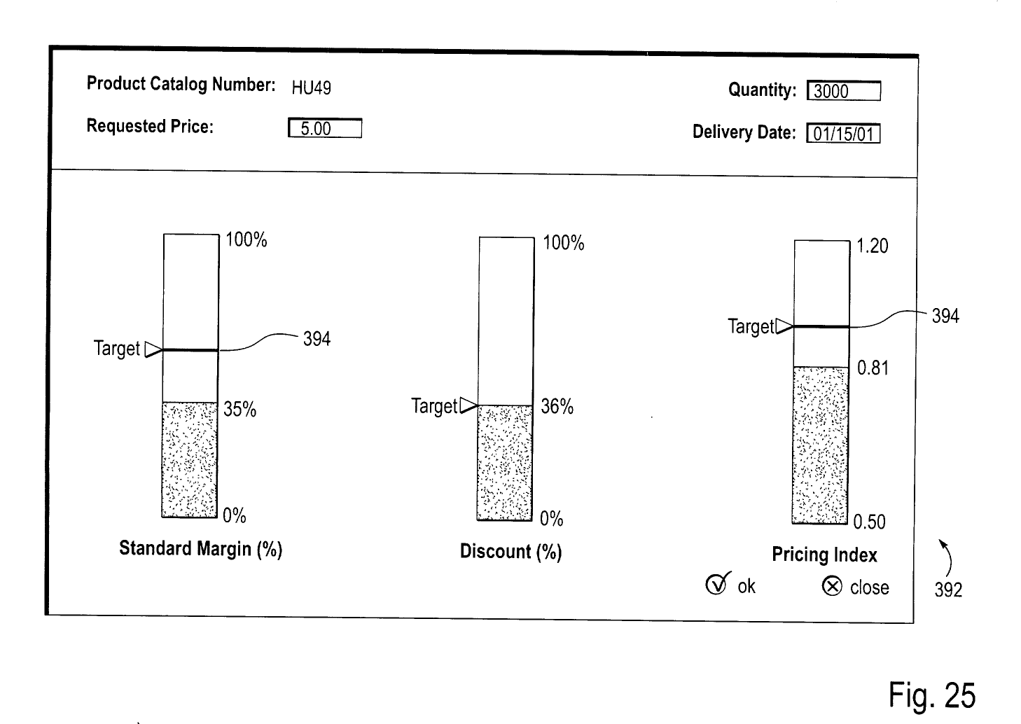

FIG. 25 illustrates an exemplary bring-to-target page 392 that displays metric functions that are used to score a line item, and target scores associated with each of these metric functions. The bring-to-target page 392 that allows a user to bring a metric value, generated by a metric function, to its target value by clicking on a target link 394 associated with each of the respective metric functions. The price and the values of other metrics are computed by the evaluation and response system 10. It should also be noted that, after bringing the metric values for the metric functions to target for example utilizing the bring-to-target page 392, the user may again invoke the analyze page 380, illustrated in FIG. 23, to perform further analysis of attribute values. In this case, the attribute values displayed by the analyze page 380 are updated in accordance with the computations performed by the evaluation and response system 10.

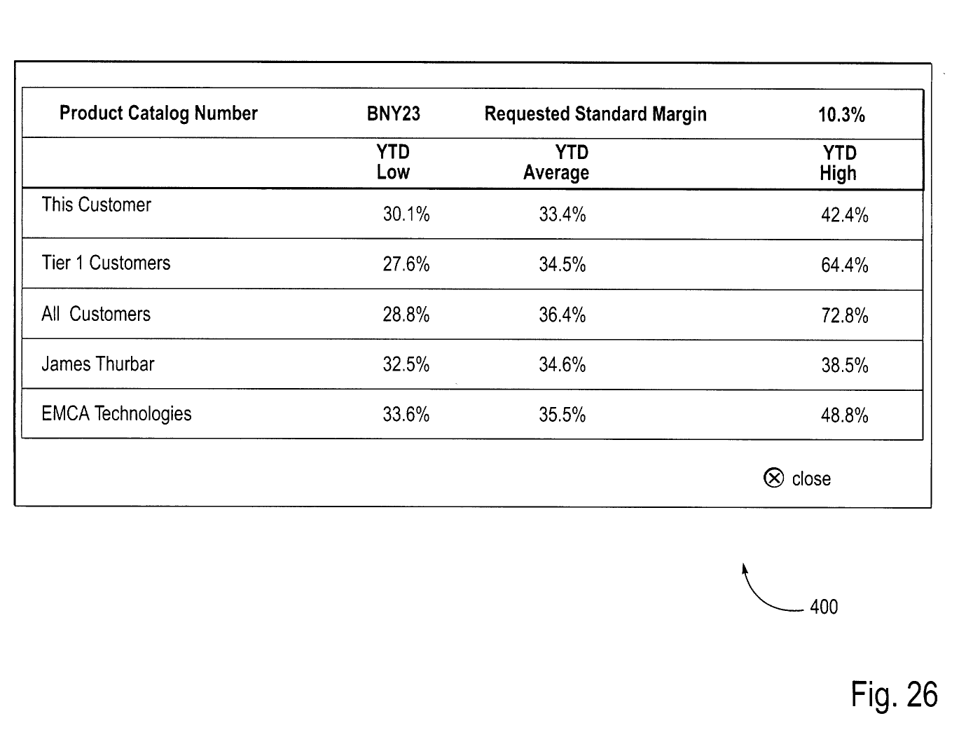

FIG. 26 illustrates an exemplary product history page 400 that displays sales statistics for the standard margin of the selected line item object 28. These sales statistics may include, for example, year-to-date low, average, and high standard margins. Each of the displayed values is shown for the customer of the current transaction request 20, all customers within a common customer tier (e.g., tier 1), all customers, all sales by the current salesperson, and all sales by a distributor. The standard margin currently requested in the selected transaction request 20 is also displayed in the top line.

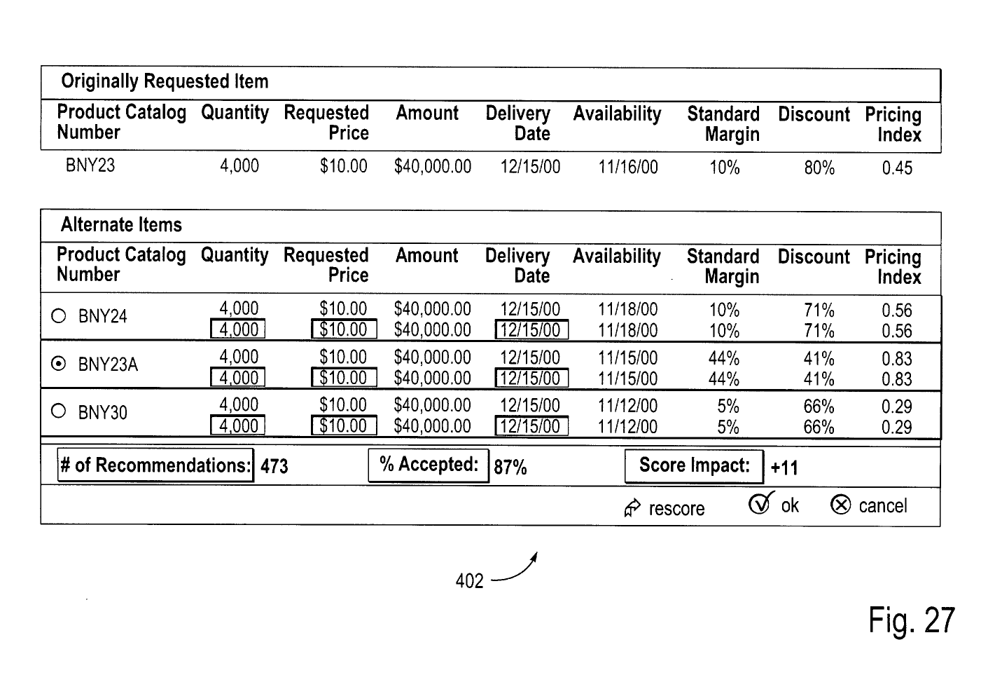

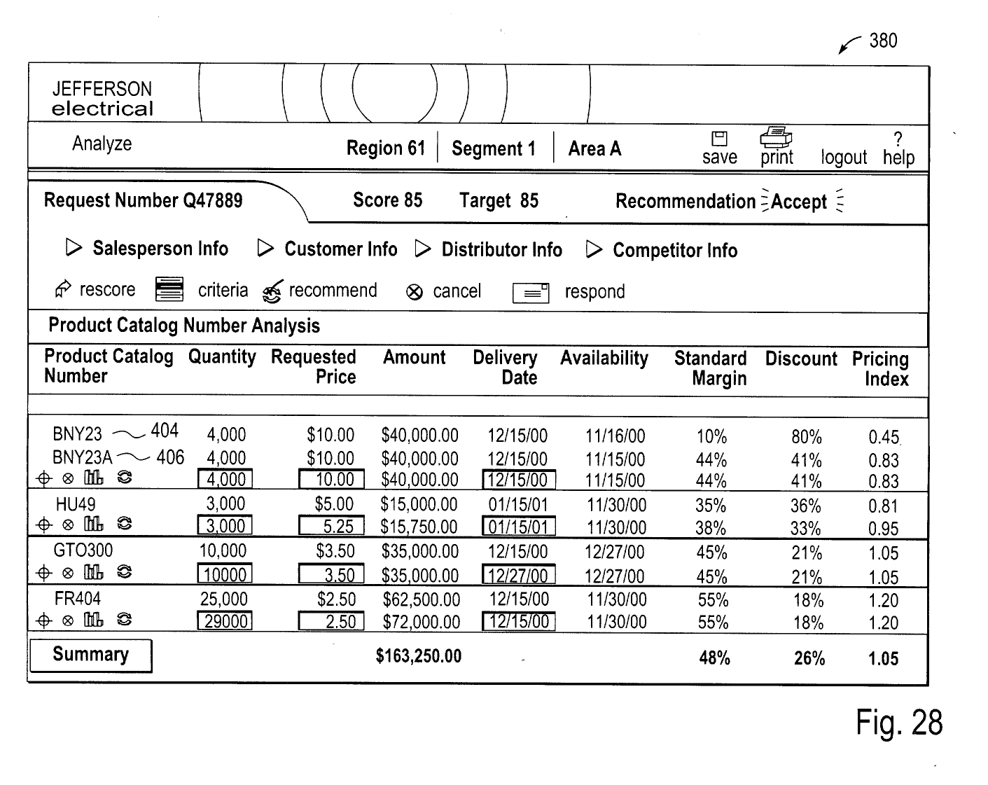

FIG. 27 illustrates an exemplary substitute page 402 that displays substitute line item object that can be substituted for a requested line item object 28. A top display line displays the line item for the requested line item object, along with attributes and metrics. For each substitute line item object, the substitute page 402 displays the appropriate attributes and metric values computed per each substitute line item object. For a selected candidate substitute line item object, the bottom line of the page 402 displays statistics of past substitutions (e.g., the number of times the product was selected as the substitute for the requested line item object 28, the percentage of times the substitution was accepted by a customer, and impact of the substitution on the request score 13). Again, after performing a substitution operation utilizing the substitute page 402, the user may again invoke the analyze page 380 to perform further analysis of attribute values. In this case, the line item objects and attribute values displayed by the analyze page 380 are updated to reflect any substitutions performed utilizing the substitute page 402. FIG. 28 illustrates the analyze page 380 updated to reflect the substitution of the line item “BNY23”, indicated at 404, with a substitute line item “BNY23A”, indicated at 406.

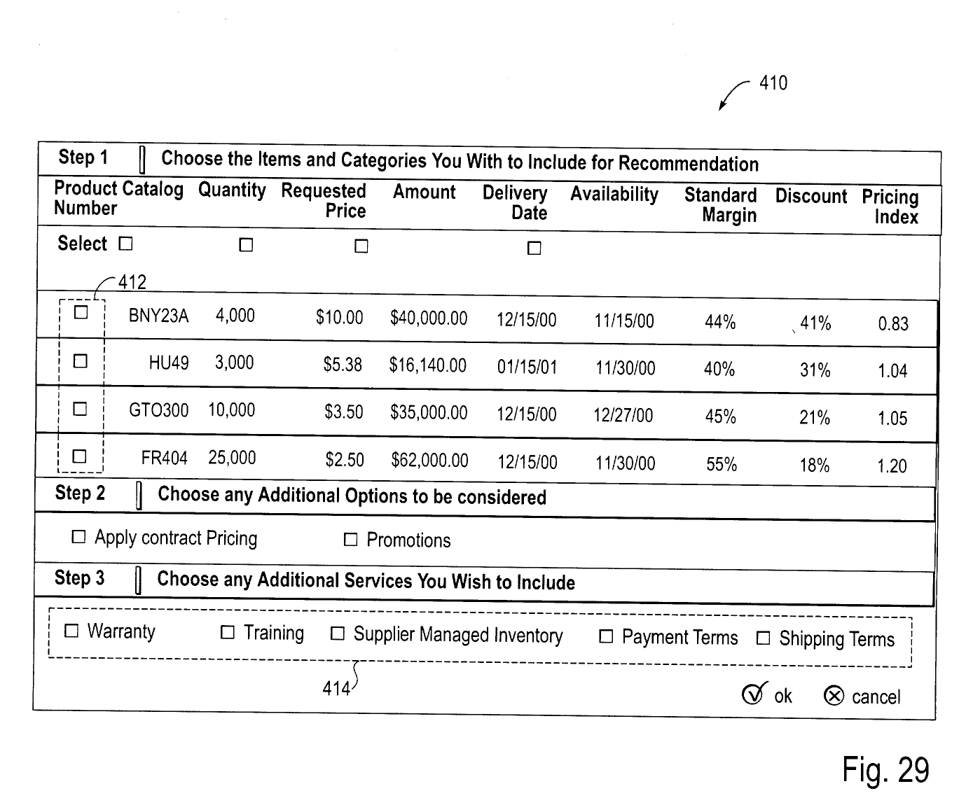

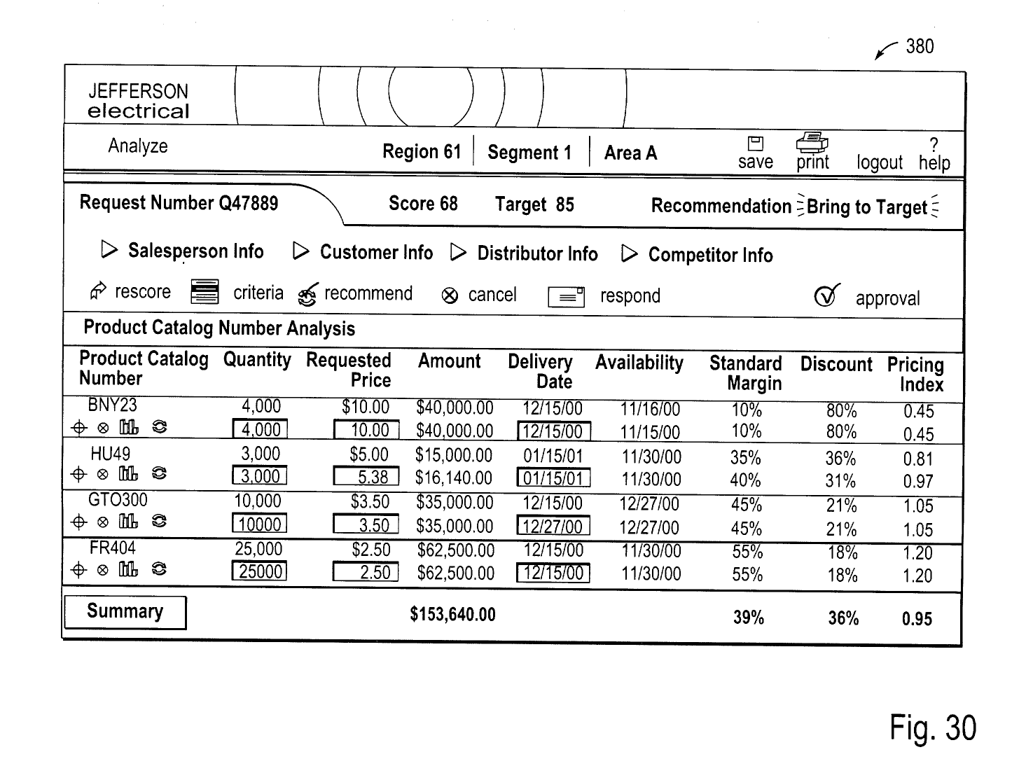

FIG. 29 illustrates an exemplary recommendation page 410, which provides the capability for a user to exercise control of the recommendation engine 14. As noted above, the recommendation engine 14 may automatically substitute line item objects, and adjust attribute values, to bring a request score 13 into conformity with a target score. By checking appropriate boxes 412 within the recommendation page 410, a user can defined constraints that restrict the line item objects and attributes that the recommendation engine 14 is authorized to modify. The user is also presented with the option of selecting boxes 414 that permit the recommendation engine 14 to consider a number of request-level attributes 22 for modification wherein the generating modified transaction requests 21 to be included within a response. For example, these request-level attributes may include warranty, training, supplier managed inventory, payment terms and shipping terms. The user is also presented the option of allowing the recommendation engine 14 to apply a contract pricing and promotions when automatically generating modified transaction requests 21. Following the execution of a recommendation operation by the recommendation engine 14, the user may again invoke the analyze page 380, as illustrated in FIG. 30, that displays recommended changes to request line item objects, and their attributes and metrics. The analyze page 380 is shown in FIG. 30, for each line item, to display the original attribute and metric values, as well as the recommended attributes and metric values.

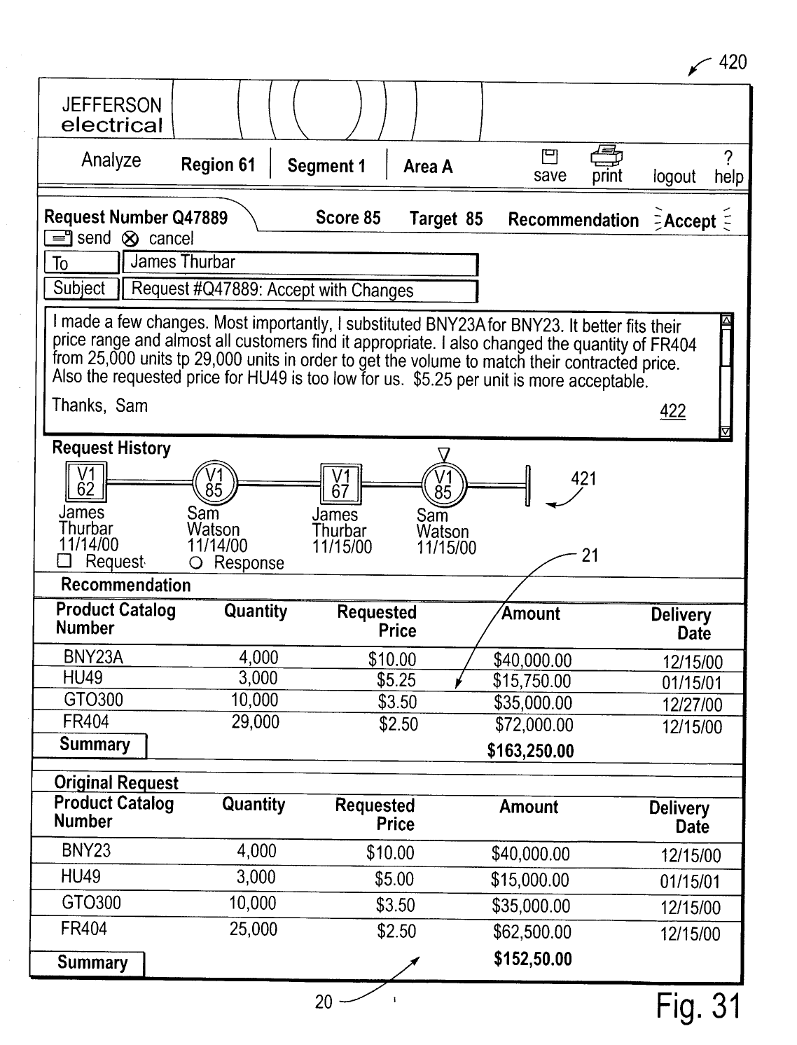

FIG. 31 illustrates an exemplary response page 420 that is generated by the evaluation and response system 10 when a user accepts a modified transaction requests 21 for inclusion within a response. The response page 420 displays an updated negotiation history 421, and information concerning two versions of the transaction request, namely the original transaction request 20 and at least one modified transaction requests 21. A text field 422 allows the user to enter notes for inclusion within the response to, for example, a salesperson.

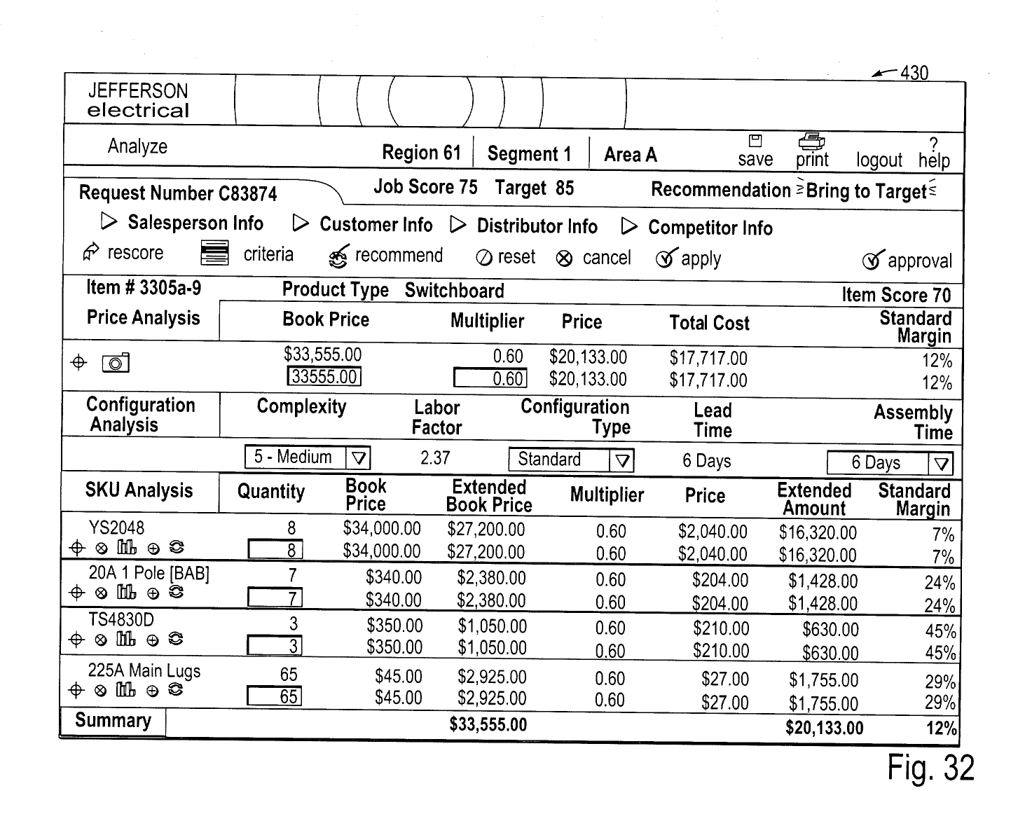

The above described user interfaces relate to an exemplary built-to-stock (BTS) transaction request 20. It will of course be appreciated that the evaluation and response system 10 may handle many other types of transaction requests such as, for example, a built-to-order transaction (BTO) request 20. A differentiating feature of built-to-order transaction requests 20 is that the evaluation and recommendation of modified transaction requests occurs on more than two levels of attributes. To this end, FIG. 32 illustrates an exemplary built-to-order analyze page 430 that enables a user to adjust attribute values of multiple levels of line item objects. The analyze page shown in FIG. 32 shows the line item components that comprises the line item “3305a”. The user is presented the option of adjusting individual attribute values for all line item objects, as well as the complexity of assembling and into a next level item. Other pages in a built-to-order process function in a similar to the pages described above for a built-to-stock process.

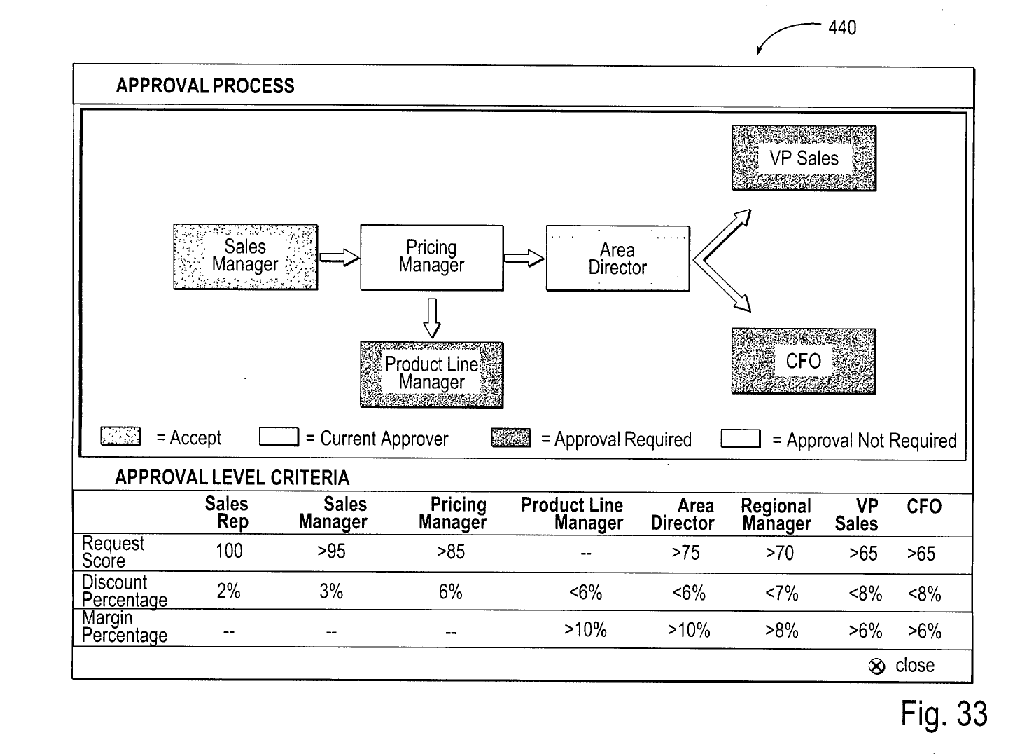

FIG. 33 illustrates an exemplary approval process page 440 that displays the current status of a particular transaction request 20 in an approval process within an organization. The bottom part of the approval process page 440 shows the levels of approval authority for the different roles in the approval process (e.g., sales representative, sales manager, pricing manager, product line manager, an area director, regional managers, vice president sales, and chief financial officer). The approval levels are specified in terms of request metrics (e.g., a request score, the discount percentage and margin percentage. The bottom part of the approval process page 440 illustrates an approval chain (e.g., approval granted (green), currently holding the request (yellow), approval required (orange), and approval not required (gray).

Computer System

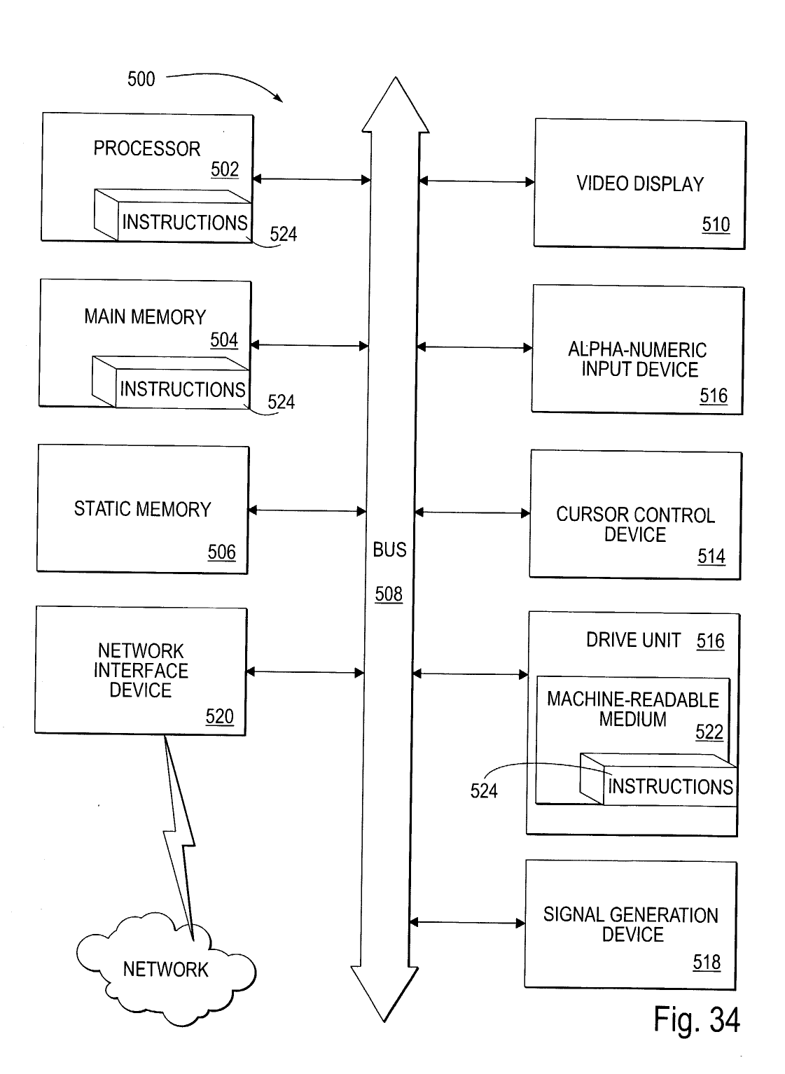

FIG. 34 is a diagrammatic representation of a machine in the exemplary form of computer system 500 within which software, in the form of a series of machine-readable instructions, for performing any one of the methods discussed above may be executed. In alternative embodiments, the machine may comprise any machine capable of executing a sequence of instructions including, but not limited to, a personal digital assistant (PDA), a mobile telephone, a network traffic device (e.g., router, bridge, switch) or handheld computing device. The computer system 500 includes a processor 502, a main memory 504 and a static memory 506, which communicate via a bus 508. The computer system 500 is further shown to include a video display unit 510 (e.g., a liquid crystal display (LCD) or a cathode ray tube (CRT)), an alphanumeric input device 512 (e.g., a keyboard), a cursor control device 514 (e.g., a mouse), a disk drive unit 516, a signal generation device 250 (e.g., a speaker) and a network interface device 522. The disk drive unit 516 accommodates a machine-readable medium 524 on which software 526 embodying any one of the methods described above is stored. The software 526 is shown to also reside, completely or at least partially, within the main memory 504 and/or within the processor 502. The software 526 may furthermore be transmitted or received by the network interface device 522. For the purposes of the present specification, the term “machine-readable medium” shall be taken to include any medium that is capable of storing or encoding a sequence of instructions for execution by a machine, such as the computer system 500, and that causes the machine to perform the methods described above. The term “machine-readable medium” shall be taken to include, but not be limited to, solid-state memories, optical and magnetic disks, and carrier wave signals.

If written in a programming language conforming to a recognized standard, the software 526 can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine, such as the computer system 500, the machine to perform an action or a produce a result.

Thus, an automated method and system to perform a supply-side evaluation of a transaction request have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A computer-implemented method to evaluate a transaction request, the method including:
identifying a plurality of objects associated with the transaction request, each of the plurality of objects including a set of the object attributes, each object attribute representing a respective attribute of the transaction request;
applying a set of metric functions, each associated with a respective metric of a plurality of metrics, against the sets of the object attributes to generate an object score for each object; and
aggregating the object scores for the plurality of objects to generate a request score indicative of an overall evaluation of the transaction request relative to an expectation for the transaction request.

2. The method of claim 1 wherein a first metric function of the set of metric functions is a function of at least one object attribute.

3. The method of claim 1 wherein the first metric function of the set of metric functions is a function of at least one object attribute and an asset attribute, wherein the asset attribute is external to the transaction request.

4. The method of claim 3 wherein the transaction is received at an evaluation system of a supplier for evaluation, a first object relates to a first asset requested from the supplier, and the asset attribute includes information of the supplier pertaining to the first asset.

5. The method of claim 1 wherein the object score for a first object is generated by applying at least one metric function of the set of metric functions to a first attribute of a set of attributes of the first object.

6. The method of claim 5 wherein the object score for the first object is generated by applying the at least one metric function of the set of metric functions to a second attribute, so that the calculation of object score for the first object is based on both of the first and second attributes.

7. The method of claim 6 wherein the second attribute is included within a set of attributes of the first object.

8. The method of claim 6 wherein the second attribute is included within a set of attributes of a second object.

9. The method of claim 5 wherein the object score for the first object is generated by applying a plurality of metric functions to attributes of the first object.

10. The method of claim 9 wherein the object score for the first object is generated by applying the plurality of metric functions to attributes of the plurality of objects.

11. The method of claim 1 wherein the plurality of metrics include any one of a price metric, a delivery date metric, a lead-time metric, a discount metric, a standard margin percentage metric, a present value of money metric, a customer ranking metric competition, a transaction volume, asset availability, capacity availability, customer location, customer business type, transaction history, transaction time with respect to business cycle, payment history, future prospects for a customer, and an asset life cycle.

12. The method of claim 1 wherein the request score is generated to have a value that is meaningful when compared to a target score, the target score representing an expected request score for the transaction request.

13. The method of claim 1 wherein the expectation for the transaction request is expressed in terms of respective target values for each of the set of metric functions.

14. The method of claim 1 wherein the plurality of objects include a line item object representing a line item within the transaction request, the line item object including a set of line item attributes.

15. The method of claim 14 wherein the plurality of objects include a bundle object representing a plurality of line item objects within the transaction request, wherein the bundle object represents a group of objects processed as a unit.

16. The method of claim 1 wherein the plurality of objects include a request level object including a set of request-level attributes.

17. The method of claim 1 wherein the set of object attributes comprises a set of line item attributes, and the set of line item attributes includes any one of a line item description, a line item price, a line item volume, a line item delivery time, a line item financing option, a line item quality, and a customer credit rating.

18. The method of claim 1 wherein the set of object attributes includes any one of discrete and continuous attributes capable of having discrete and continuous attributes values, respectively.

19. The method of claim 1 wherein the set of object attributes includes an argument attribute having an attribute value that is an argument within a metric function of the set of metric functions.

20. The method of claim 1 wherein the set of object attributes includes a target modifier attribute having a target modifier value that modifies a target value associated with a metric function of the set of metric functions.

21. The method of claim 1 wherein the application of the set of metric functions includes applying a different set of metric functions against each set of object attributes for each object.

22. The method of claim 1 wherein the generation of the object score for a first object of the plurality of objects includes applying at least one metric function of the set of metric functions against a set of object attributes for the first object to generate at least one metric value for the first object.

23. The method of claim 22 wherein the generation of the object score for the first object includes applying at least one normalizing function to the at least one metric value for the first object to generate at least one normalized metric value for the first object, the at least one normalized metric value reflecting the at least one metric value with respect to a normalized scale for a respective metric, wherein the normalized scale is normalized with respect to a target value for the respective metric.

24. The method of claim 23 including applying a plurality of metric functions of the set of metric functions against the set of object attributes for first object to generate a plurality of metric values for at first object.

25. The method of claim 24 wherein the generation of the object score for the first object includes applying a plurality of normalizing functions to the plurality of metric values for at least the first object to generate a plurality of normalized metric values for the first object of the plurality of objects, each of the plurality of normalized metric values reflecting to a metric value of the plurality of metric values with respect to a normalized scale for a respective metric.

26. The method of claim 25 wherein the generation of the object score for the first object includes aggregating the plurality of normalized metric values for each object.

27. The method of claim 26 wherein the aggregation of the plurality of normalized metric values includes any one of a group of aggregation methods including calculating a sum of the plurality of normalized metric values, calculating a product of the plurality of normalized metric values, selecting a minimum normalized metric value from the plurality of normalized metric values, and selecting a maximum normalized metric value from the plurality of normalized metric values.

28. The method of claim 26 wherein the aggregation of the plurality of normalized metric values includes applying different weightings to first and second normalized metric values of the plurality of normalized metric values.

29. The method of claim 28 wherein the aggregation of the plurality of normalized metric values includes calculating a weighted sum of the plurality of normalized metric values.

30. The method of claim 1 including determining at least one reference value for a first metric of the plurality of metrics.

31. The method of claim 30 wherein the at least one reference value comprises a target reference value that is calculated for the first metric with respect to the normalized scale for the first metric, the target reference value indicating a normalized metric value.

32. The method of claim 30 including determining a plurality of reference values for each metric of the plurality of metrics.

33. The method of claim 32 wherein a first normalizing function of the plurality of normalizing functions is defined in terms of the plurality of reference values.

34. The method of claim 33 wherein an application of the first normalizing function includes determining whether a first metric value for a first object corresponds to any one of the plurality of reference values and, if so, then setting a corresponding reference value of the plurality of reference values as a first normalized metric value corresponding to the first metric value.

35. The method of claim 34 wherein, if the first metric value does not correspond to any one of the reference values, then either interpolating or extrapolating from the plurality of reference values to determine the normalized metric value corresponding to the first metric value.

36. The method of claim 35 wherein the interpolating or the extrapolating includes applying either a convex or a concave function between any two of the plurality of reference values.

37. The method of claim 1 wherein the object score for the first object is generated by applying the set of metric functions to metric values outputted via the plurality of metric functions with respect to the first object, or with respect to other objects of the plurality of objects.

38. The method of claim 25 including iteratively recalculating the plurality of normalized metric values until equilibrium between the normalized metric values is reached.

39. The method of claim 32 wherein the plurality of reference values include maximum and minimum reference values, and a normalized scale for a respective metric is bound by the minimum and maximum reference values.

40. The method of claim 39 wherein a zero reference value is calculated for the respective metric with respect to the normalized scale for the respective metric.

41. The method of claim 40 wherein the zero reference value corresponds to the minimum reference value.

42. The method of claim 1 wherein the aggregating of the object scores includes weighing each of the objects scores to generate a weighted object score.

43. The method of claim 1 including summing weighted object scores for each of the objects to generate a weighted score summary.

44. The method of claim 1 wherein the aggregation of the object scores is performed hierarchically utilizing a score aggregation function.

45. The method of claim 1 wherein the aggregation of the object scores includes any one of a group of aggregation methods including selection of a maximum object score from among the object scores and selection of a minimum object score from among the object scores.

46. The method of claim 16 including identifying at least one request level attribute of the request level object, the at least one request level attribute indicating an attribute pertaining generally to the transaction request.

47. The method of claim 46 wherein the at least one request level attribute includes any one of a group of attributes including a customer tier for a customer issuing the transaction request, a contract value for the customer issuing the transaction request, a revenue pressure value, a dollar volume associated with the transaction request, customer payment history and credit level.

48. The method of claim 46 including applying a request-level metric function against the at least one request level attribute to generate a request-level attribute score.

49. The method of claim 1 including identifying a plurality of request level attributes of the request level object, applying a plurality of request-level metric functions against each of the plurality of request level attributes to generate a request-level attribute score.

50. The method of claim 49 including combining the object scores and the request-level attribute score to generate the request score.

51. The method of claim 1 wherein the transaction request includes any one of a request for quote (RFQ), a request for price agreement and an order.

52. The method of claim 1 wherein in the plurality of objects comprises any one of a linear data structure and a hierarchical data structure.

53. The method of claim 1 including receiving the transaction request at a transaction evaluation system, and generating the request score utilizing the transaction evaluation system.

54. The method of claim 54 wherein the transaction evaluation system is deployed by an asset supplier to evaluate a transaction request relating to an asset provided by the asset supplier.

55. An evaluation system to evaluate a transaction request including a plurality of objects associated with the transaction request, each of the plurality of objects including a set of the object attributes, each object attribute representing a respective attribute of the transaction request, the system comprising:
a set of metric functions, each associated with a respective metric of a plurality of metrics, to be applied against the sets of the object attributes and to generate an object score for each object; and
an aggregator to aggregate the object scores for the plurality of objects to generate a request score indicative of an overall evaluation of the transaction request relative to an expectation for the transaction request.

56. The system of claim 55 wherein a first metric function of the set of metric functions is a function of at least one object attribute.

57. The system of claim 55 wherein the first metric function of the set of metric functions is a function of at least one object attribute and an asset attribute, wherein the asset attribute is external to the transaction request.

58. The system of claim 57 wherein the transaction is received at the evaluation system of a supplier for evaluation, a first object relates to a first asset requested from the supplier, and the asset attribute includes information of the supplier pertaining to the first asset.

59. The system of claim 55 wherein the object score for a first object is generated by applying at least one metric function of the set of metric functions to a first attribute of a set of attributes of the first object.

60. The system of claim 59 wherein the object score for the first object is generated by applying the at least one metric function of the set of metric functions to a second attribute, so that the calculation of object score for the first object is based on both of the first and second attributes.

61. The system of claim 55 wherein the plurality of metrics include any one of a price metric, a delivery date metric, a lead-time metric, a discount metric, a standard margin percentage metric, a present value of money metric, a customer ranking metric competition, a transaction volume, asset availability, capacity availability, customer location, customer business type, transaction history, transaction time with respect to business cycle, payment history, future prospects for a customer, and an asset life cycle.

62. The system of claim 55 wherein the request score is generated to have a value that is meaningful when compared to a target score, the target score representing an expected request score for the transaction request.

63. The system of claim 55 wherein the expectation for the transaction request is expressed in terms of respective target values for each of the set of metric functions.

64. The system of claim 55 wherein the plurality of objects include a line item object representing a line item within the transaction request, the line item object including a set of line item attributes.

65. The system of claim 55 wherein the plurality of objects include a request level object including a set of request-level attributes.

66. The system of claim 55 wherein at least one metric function of the set of metric functions is to be applied against a set of object attributes for the first object to generate at least one metric value for the first object..

67. The system of claim 66 including at least one normalizing function to be applied to the at least one metric value for the first object to generate at least one normalized metric value for the first object, the at least one normalized metric value reflecting the at least one metric value with respect to a normalized scale for a respective metric, wherein the normalized scale is normalized with respect to a target value for the respective metric..

68. The system of claim 67 wherein a plurality of metric functions of the set of metric functions is to be applied against the set of object attributes for first object to generate a plurality of metric values for at first object.

69. The system of claim 68 including a plurality of normalizing functions to be applied to the plurality of metric values for at least the first object to generate a plurality of normalized metric values for the first object of the plurality of objects, each of the plurality of normalized metric values reflecting to a metric value of the plurality of metric values with respect to a normalized scale for a respective metric.

70. The system of claim 69 wherein the aggregator is to generate of the object score for the first object includes aggregating the plurality of normalized metric values for each object.

71. The system of claim 55 including a normalizing function to determine at least one reference value for a first metric of the plurality of metrics.

72. The system of claim 71 wherein the normalizing function is to calculate the at least one reference value as a target reference value that is calculated for the first metric with respect to a normalized scale for the first metric, the target reference value indicating a normalized metric value.

73. The system of claim 71 wherein the normalizing function to determine a plurality of reference values for each metric of the plurality of metrics.

74. The system of claim 73 wherein the normalizing function includes a first normalizing function of the plurality of normalizing functions that is defined in terms of the plurality of reference values.

75. The system of claim 74 wherein an application of the first normalizing function is to determine whether a first metric value for a first object corresponds to any one of the plurality of reference values and, if so, then to set a corresponding reference value of the plurality of reference values as a first normalized metric value corresponding to the first metric value.

76. The system of claim 75 wherein, if the first metric value does not correspond to any one of the reference values, then the first normalizing function is to either interpolate or extrapolate from the plurality of reference values to determine the normalized metric value corresponding to the first metric value.

77. The system of claim 69 wherein the normalizing function is to iteratively recalculate the plurality of normalized metric values until an equilibrium between the normalized metric values is reached.

78. The system of claim 55 wherein the aggregator is to weigh each of the objects scores to generate a weighted object score.

79. The system of claim 55 wherein the aggregator is to sum weighted object scores for each of the objects to generate a weighted score summary.

80. An evaluation system to evaluate a transaction request including a plurality of objects associated with the transaction request, each of the plurality of objects including a set of the object attributes, each object attribute representing a respective attribute of the transaction request, the system comprising:
metric means for application against the sets of the object attributes and for generating an object score for each object; and
aggregator means for aggregating the object scores for the plurality of objects to thereby generate a request score indicative of an overall evaluation of the transaction request relative to an expectation for the transaction request.

81. A machine-readable medium storing a set of instructions that, when executed by a machine, cause the machine to:
identify a plurality of objects associated with a transaction request, each of the plurality of objects including a set of the object attributes, each object attribute representing a respective attribute of the transaction request;
apply a set of metric functions, each associated with a respective metric of a plurality of metrics, against the sets of the object attributes to generate an object score for each object; and
aggregate the object scores for the plurality of objects to generate a request score indicative of an overall evaluation of the transaction request relative to an expectation for the transaction request.
